(19) United States
(12) Patent Application Publication
(10) Pub. No.: US 2026/0368720 A1
(43) Pub. Date: Nov. 19, 2026

(54) SYSTEM AND METHOD FOR DYNAMICALLY MAINTAINING A CREATOR-LINKED DIGITAL ASSET PLATFORM

(71) Applicant: READY PLAYER X INDIA PRIVATE LIMITED, Gurugram (IN)

(72) Inventor: Varun Kapoor, Gurugram (IN)

(21) Appl. No.: 19/676,934

(22) Filed: May 14, 2026

(30) Foreign Application Priority Data
May 14, 2025 (IN) 202511046424

(51) Int. Cl. G06Q 20/38

(52) U.S. Cl. CPC G06Q 20/381; G06Q 2220/00

(57) ABSTRACT

A system and method for dynamically maintaining a creator-linked digital asset platform is disclosed. The method includes receiving, by a computing device from one or more data sources, heterogeneous real-time event data streams corresponding to a creator and a current circulation state corresponding to a creator-linked digital asset associated with the creator. The real-time event data includes a set of asynchronous data elements. The method further includes preprocessing the heterogeneous real-time event data streams to determine a set of activity metrics. The method further includes synchronizing the standardized activity metrics with the circulation state to generate a composite state representation. The method further includes dynamically determining a current indexed value of the creator-linked digital asset based on the composite state representation using a predefined valuation function. The method further includes outputting the current indexed value to a transaction interface for enabling subsequent operations associated with the creator-linked digital asset.

A portion of the disclosure of this patent document contains material, which is subject to copyright and/or mask work protection. The copyright and/or mask work owner has no objection to the facsimile reproduction by anyone of the patent document or the patent disclosure, as it appears in the Patent and Trademark Office patent file or records, but otherwise reserves all copyright and/or mask work rights whatsoever.

### FIELD OF THE INVENTION

This invention relates to the field of digital currency platforms and financial technology systems, specifically to a method and system for converting fiat currency into a platform-native currency. The platform-native currency is pegged to a fractional value of a reference asset (for example, Bitcoin). The method and system utilize a treasury mechanism to back the issued platform currency and ensure stability and trust within the platform.

### BACKGROUND

Traditional platforms lack a seamless and dynamic method for users to convert fiat currency into a stable digital currency that can be used natively within a platform. Users face complexities and uncertainties when dealing with cryptocurrency volatility during conversions. There is a need for a system that provides a stable, transparent, and secure means of converting fiat to a platform-native currency, ensuring ease of use and trust. Current fiat-to-crypto systems often involve multiple steps and lack integration with platform-specific currencies. Stablecoins exist but may not be natively integrated into specific platforms or may lack a transparent backing mechanism.

Additionally, conventional digital asset platforms and creator-economy systems typically rely on static valuation mechanisms, manually adjustable pricing models, or order-book-based transaction architectures that are unable to dynamically reflect rapidly changing creator-related activity across multiple external environments. Such existing digital asset platforms also generally fail to efficiently process heterogeneous real-time event data streams related to the creators originating from disparate sources such as social media platforms, content distribution systems, offline event systems, and news feeds. As a result, conventional systems are often unable to maintain synchronized relationships between creator activity, asset circulation state, and asset valuation in real time.

Accordingly, there exists a need for improved systems and methods capable of dynamically maintaining creator-linked digital asset platforms through real-time processing of heterogeneous creator-related event data, synchronized circulation-state management, reserve-coupled valuation mechanisms, deterministic minting and burning operations, and coordinated acquisition-side and disposition-side transaction processing.

### SUMMARY

In one embodiment, a method for dynamically maintaining a creator-linked digital asset platform is disclosed. In one example, the method may include receiving, from one or more data sources, heterogeneous real-time event data streams corresponding to a creator and a current circulation state corresponding to a creator-linked digital asset associated with the creator. The real-time event data may include a set of asynchronous data elements. The method may further include preprocessing the heterogeneous real-time event data streams to determine a set of activity metrics. The method may further include synchronizing the standardized activity metrics with the circulation state to generate a composite state representation. The method may further include dynamically determining a current indexed value of the creator-linked digital asset based on the composite state representation using a predefined valuation function. The method may further include outputting the current indexed value to a transaction interface for enabling subsequent operations associated with the creator-linked digital asset.

In one embodiment, a system for dynamically maintaining a creator-linked digital asset platform is disclosed. In one example, the system may include a processor and a memory communicatively coupled to the processor. In one example, the memory may store processor-executable instructions, which, on execution, may cause the processor to receive, from one or more data sources, heterogeneous real-time event data streams corresponding to a creator and a current circulation state corresponding to a creator-linked digital asset associated with the creator. The real-time event data includes a set of asynchronous data elements. The processor-executable instructions, on execution, may further cause the processor to preprocess the heterogeneous real-time event data streams to determine a set of activity metrics. The processor-executable instructions, on execution, may further cause the processor to synchronize the standardized activity metrics with the circulation state to generate a composite state representation. The processor-executable instructions, on execution, may further cause the processor to dynamically determine a current indexed value of the creator-linked digital asset based on the composite state representation using a predefined valuation function. The processor-executable instructions, on execution, may further cause the processor to output the current indexed value to a transaction interface for enabling subsequent operations associated with the creator-linked digital asset.

In one embodiment, a non-transitory computer-readable medium storing computer-executable instructions for dynamically maintaining a creator-linked digital asset platform is disclosed. In one example, the stored instructions, when executed by a processor, cause the processor to perform operations including receiving, from one or more data sources, heterogeneous real-time event data streams corresponding to a creator and a current circulation state corresponding to a creator-linked digital asset associated with the creator, wherein the real-time event data comprises a set of asynchronous data elements. The operations further include preprocessing the heterogeneous real-time event data streams to determine a set of activity metrics. The operations further include synchronizing the standardized activity metrics with the circulation state to generate a composite state representation. The operations further include dynamically determining a current indexed value of the creator-linked digital asset based on the composite state representation using a predefined valuation function. The operations further include outputting the current indexed value to a transaction interface for enabling subsequent operations associated with the creator-linked digital asset.

Certain embodiments of the present disclosure described herein relate to a system and method for users to convert mat currency into a platform-native digital currency called BlackFlame® Dollar (BFD) here. For example, BFD is equal to a fixed fraction of a reference asset (e.g., 1 BFD= 1/10,000th of a Bitcoin), ensuring stability. The system integrates with multiple fiat-to-bitcoin providers, allowing for flexibility and scalability. A treasury mechanism stores the reference asset equivalent to the total BFD in circulation, backing the issued tokens and maintaining user trust. The platform manages real-time conversions, treasury holdings, and future redemption processes. Other embodiments of this aspect include corresponding computer systems, apparatus, and computer programs recorded on one or more computer storage devices, each configured to perform the actions of the methods.

It is to be understood that both the foregoing general description and the following detailed description are exemplary and explanatory only and are not restrictive of the invention, as claimed.

### BRIEF DESCRIPTION OF THE DRAWINGS

The present disclosure is described in conjunction with the appended figures:

FIG. 1 is a block diagram of an exemplary system for dynamically maintaining a creator-linked digital asset platform, according to an embodiment of the present disclosure;

FIG. 2A illustrates a block diagram of a system, according to an embodiment of the present disclosure;

FIG. 2B illustrates a flow diagram of a system according to an embodiment of the present disclosure;

FIG. 3 illustrates a block diagram of a currency-to-cryptocurrency integration layer according to an embodiment of the present disclosure;

FIG. 4 illustrates a block diagram of a chest mechanism module according to an embodiment of the present disclosure;

FIG. 5 illustrates a block diagram of a logarithmic curve module according to an embodiment of the present disclosure;

FIG. 6 illustrates a block diagram of an additional coins according to an embodiment of the present disclosure;

FIG. 7 illustrates a block diagram of a social media integration according to an embodiment of the present disclosure;

FIG. 8 illustrates a block diagram of an account association module according to an embodiment of the present disclosure;

FIG. 9 illustrates a block diagram of an artificial intelligence (AI) assistant according to an embodiment of the present disclosure;

FIG. 10 illustrates a block diagram of a payment gateway according to an embodiment of the present disclosure;

FIG. 11 illustrates a block diagram of an investment platform according to an embodiment of the present disclosure;

FIG. 12A illustrates a flow diagram of an exemplary process for dynamically maintaining a creator-linked digital asset platform, according to an embodiment of the present disclosure;

FIG. 12B illustrates a flow diagram of an exemplary process for performing acquisition-event-driven reserve updating, minting, circulation-state updating, and fractional allocation associated with a creator-linked digital asset, according to an embodiment of the present disclosure;

FIG. 12C illustrates a flow diagram of an exemplary process for performing disposition-event-driven burning, circulation-state reduction, reserve release, and payout allocation associated with a creator-linked digital asset, according to an embodiment of the present disclosure;

FIGS. 13-23 illustrates graphical user interfaces (GUIs) of a platform of a system in accordance with an embodiment of the present disclosure;

FIG. 24 illustrates a flowchart describing a process for users to convert fiat currency into a platform-native digital currency called BlackFlame® Dollar (BFD) in accordance with another embodiment of the present disclosure;

FIG. 25 illustrates a flowchart describing a process for Off-Ramp feature allows users to convert their BlackFlame® Dollar (BFD) either into fiat currency or directly into bitcoin in accordance with another embodiment of the present disclosure;

FIG. 26 illustrates a flowchart describing a process for performing dynamic community chest mechanism to collect a percentage of all coins bought and sold on a platform of a system in accordance with another embodiment of the present disclosure;

FIG. 27 illustrates a flowchart describing a process for logarithmic curve to regulate a price growth in accordance with another embodiment of the present disclosure;

FIG. 28A illustrates a flowchart describing a process for users to earn Experience Points (XP) through trading activities and level up, unlocking new features such as additional coin slots and higher trade limits in accordance with another embodiment of the present disclosure;

FIG. 28B illustrates a flowchart describing a process for users earn XP through trading activities and level up, unlocking new features such as additional coin slots and higher trade limits based on availability of slots in accordance with another embodiment of the present disclosure;

FIG. 29 illustrates a flowchart describing a process for social media integration for coin creation and verification in accordance with another embodiment of the present disclosure;

FIG. 30 illustrates a flowchart describing a process for a digital trading platform that integrates real-time social media content with user-generated stock coins in accordance with another embodiment of the present disclosure;

FIG. 31 illustrates a flowchart describing a process for a personalized AI assistant that replicates a user's voice and provides guidance within a system in accordance with another embodiment of the present disclosure;

FIG. 32 illustrates a flowchart describing a process for allowing influencers and individual businesses to create and manage proprietary digital coins in accordance with another embodiment of the present disclosure; and

FIG. 33 illustrates a flowchart describing a process for aggregated dynamic social media timeline integration in a user investment platform in accordance with another embodiment of the present disclosure.

FIGS. 34A and 34B illustrate a flowchart describing a process for buy-side event-driven minting and state advancement, in accordance with another embodiment of the present disclosure.

FIGS. 35A and 35B illustrate a flowchart describing a process for sell-side event-driven burning and state reduction flow, in accordance with another embodiment of the present disclosure.

FIG. 36 illustrates a flowchart describing a process for executing, pricing, allocating, and recording fractional ownership interests in creator-linked coins based on a user-specified transaction value, in accordance with another embodiment of the present disclosure.

FIG. 37 illustrates a flowchart describing a process for creator-linked coin compensation and selectable settlement architecture, in accordance with another embodiment of the present disclosure.

FIG. 38 illustrates a flowchart describing a process for dynamically changing creator incentive percentages, in accordance with another embodiment of the present disclosure.

FIG. 39 illustrates a flowchart describing a process for selective visibility of digital asset holder information, in accordance with another embodiment of the present disclosure.

FIG. 40 illustrates a flowchart describing a process for direct fiat-backed BFD issuance and reserve architecture, in accordance with another embodiment of the present disclosure.

FIG. 41 illustrates a flowchart describing a process for reserve linkage and value determination, in accordance with another embodiment of the present disclosure.

In the appended figures, similar components and/or features may have the same reference label. Further, various components of the same type may be distinguished by following the reference label with a second alphabetical label that distinguishes among the similar components. If only the first reference label is used in the specification, the description applies to any one of the similar components having the same first reference label irrespective of the second reference label.

### DETAILED DESCRIPTION

The ensuing description provides preferred exemplary embodiment(s) only and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

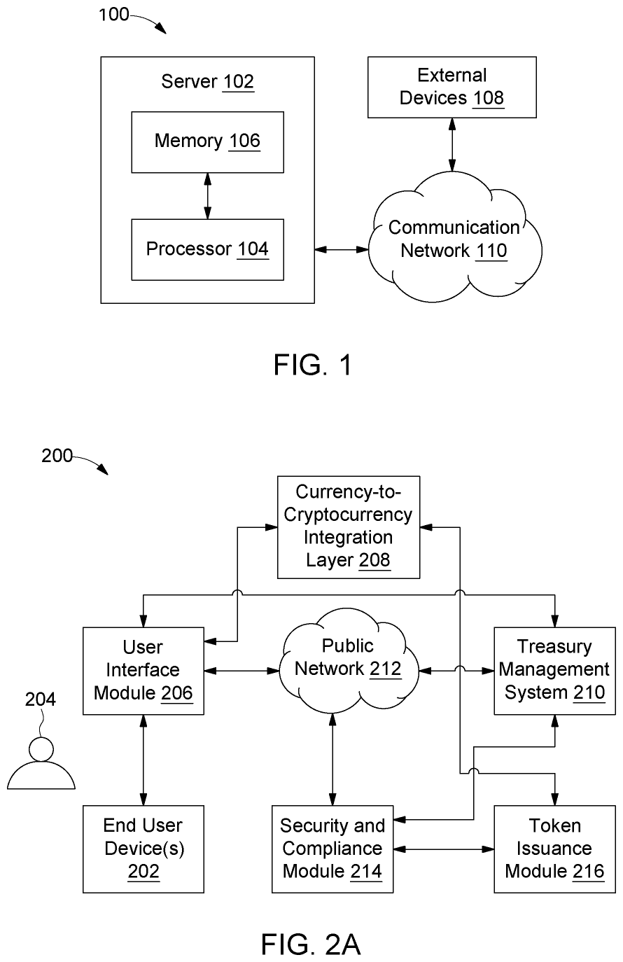

Referring now to FIG. 1, an exemplary system 100 for dynamically maintaining a creator-linked digital asset platform is illustrated, according to an embodiment of the present disclosure. The system 100 may implement a server 102 (for example, centralized server, a cloud server, multiple servers in a distributed-architecture, or the like), in accordance with some embodiments of the present disclosure. The server 102 may dynamically maintain a creator-linked digital asset platform through real-time processing of creator-associated event data, dynamic valuation of creator-linked digital assets based on circulation and reserve states, and responsive minting, burning, and settlement operations associated with acquisition and disposition events.

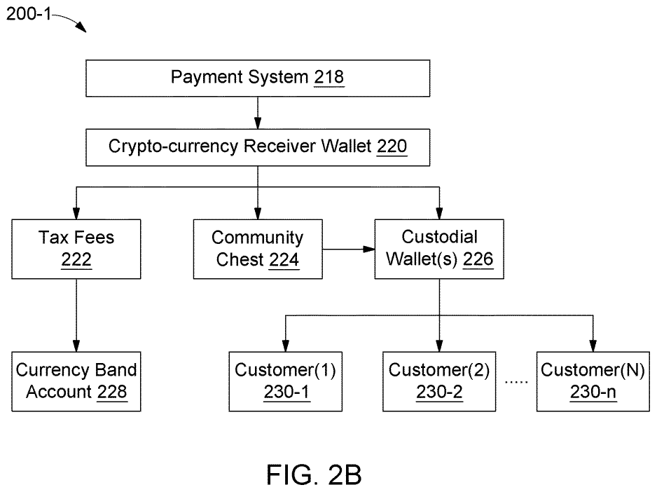

As will be described in greater detail in conjunction with FIGS. 2A-B-33, the server 102 receives, from one or more data sources, heterogeneous real-time event data streams corresponding to a creator and a current circulation state corresponding to a creator-linked digital asset associated with the creator. The real-time event data includes a set of asynchronous data elements. The server 102 further preprocesses the heterogeneous real-time event data streams to determine a set of activity metrics. The server 102 further synchronizes the standardized activity metrics with the circulation state to generate a composite state representation. The server 102 further dynamically determines a current indexed value of the creator-linked digital asset based on the composite state representation using a predefined valuation function. The server 102 further outputs the current indexed value to a transaction interface for enabling subsequent operations associated with the creator-linked digital asset.

In some embodiments, the server 102 may include one or more processors 104 and a memory 106. The memory 106 may include a state database. Further, the memory 106 may store instructions that, when executed by the one or more processors 104, cause the one or more processors 104 to dynamically maintain the creator-linked digital asset platform, in accordance with aspects of the present disclosure. The memory 106 may also store various data (for example, indexed values, user account data, ownership records, state database (i.e., treasury-associated value store), transaction logs, and the like) that may be captured, processed, and/or required by the system 100.

The system 100 may also include one or more external devices 108. In some embodiments, the server 102 may interact with the one or more external devices 108 over a communication network 110 for sending or receiving various data. The communication network 110 may be a wired communication network, a wireless communication network, or a combination thereof. The external devices 108 may include, but may not be limited to, a remote server, a digital device (such as user devices), or another computing system.

Referring to FIG. 2A, illustrates a block diagram of a system 200, according to an embodiment of the present disclosure. In an embodiment, the system 200 may be implemented by the system 100. The system 200 includes end-user device(s) 202, end user(s) 204, user interface module 206, Currency-to-Cryptocurrency Integration Layer 208, treasury management system 210, public network(s) 212, security and compliance module 214, and token issuance module 216. In an embodiment, the user interface module 206, the Currency-to-Cryptocurrency Integration Layer 208, the treasury management system 210, the security and compliance module 214, and the token issuance module 216 may be included within the memory 106. The Different components of system 200 are connected via the public network(s) 212. The public network(s) 212 can provide a wireless connection with other components.

In some configurations, the system 200 facilitates a seamless currency-to-cryptocurrency conversion for users, enabling them to purchase a proprietary token referred as BlackFlame® Dollar (BFD), which is pegged to a preset ratio (for example, 1/10000th) of the cryptocurrency. An example of cryptocurrency is Bitcoin. The system 200 integrates with currency-to-bitcoin providers, managing a Bitcoin treasury, and issuing the equivalent amount of BFD to the end user(s) 204. While Bitcoin is used as the reference asset, the system 200 can be adapted to use other cryptocurrencies or assets.

Currency integration provided by the system 200 enables users/end-users 204 make payments in various fiat currencies (e.g., USD, EURO, etc.). The platform is structured to allow multiple fiat-to-bitcoin providers to be used, providing flexibility for future expansion.

Initial provider such as Moonpay® but the platform architecture supports additional providers (e.g., Coinbase Commerce, Simplex) for scalability. The architecture allows for seamless addition of new fiat-to-crypto providers as the platform expands into new markets.

Payment methods include fiat transactions can occur through various methods (bank transfers, credit/debit cards, etc.), depending on the provider's capabilities. The platform provides users with a clear breakdown of any fees associated with transactions and offers information to help users understand the relationship between BFD and the reference asset.

BFD Issuance by the system 200 indicates that once fiat payment is processed, the platform purchases an equivalent value of Bitcoin through the selected provider. A corresponding number of BFD (pegged to 1/10000 of a Bitcoin) are then credited to the user's account.

In an example embodiment, a user pays $100 via a credit card. The platform purchases $100 worth of Bitcoin and credits the user with the equivalent BFD, calculated based on the real-time value of Bitcoin. The system 200 implements mechanisms to adjust the ratio under certain conditions to maintain stability.

Treasury mechanism of the system 200 includes that all purchased Bitcoin is stored in the platform's treasury. This treasury ensures the backing of all issued BFD, maintaining stability and trust.

Bitcoin storage includes the treasury that automatically holds Bitcoin equal to the BFD in circulation.

Real-time conversion of the value of BFD is dynamically pegged to Bitcoin. As Bitcoin's value changes, so does the equivalent value of BFD.

Multi-provider flexibility of the platform architecture is designed to handle various fiat-to crypto providers. This flexible system enables smooth integration of new providers in the future without interrupting platform functionality.

Dynamic multi-provider fiat to crypto system includes the architecture's flexibility to work with multiple fiat-to-crypto providers, enabling seamless scalability while minimizing disruption.

Real-time currency-to-bitcoin conversion with BFD Issuance has a proprietary system for converting fiat into bitcoin and issuing a stablecoin (BFD) that is always pegged to a fixed fraction of Bitcoin.

Treasury-backed stablecoin issuance system of the system 200 has a treasury system where the amount of BFD issued is dynamically pegged to the value of Bitcoin, ensuring stability and transparency for users.

The future redemption process includes a flow for the redemption of BFD into Bitcoin, governed by smart contracts and treasury management.

Seamless conversion includes users who can easily convert fiat currency into BFD without dealing directly with cryptocurrency complexities.

Stability and trust: The treasury mechanism ensures that all BFD issued are backed by the reference asset, providing transparency and security.

Flexibility and scalability: Integration with multiple providers allows the platform to adapt and expand without service interruptions.

Platform integration BFD of the system 200 serves as the native currency within the platform, enhancing functionality and user experience. The platform could integrate additional financial services, such as lending or staking, using BFD.

The user interface module 206 allows the end users 204 to interact with the payment platforms, initiate payments, and manage BFD holdings. The payments can be made in currency such as USD, EURO, etc. also referred to as fiat. The payments can be made using a digital wallet or payment gateway, credit cards, debit cards etc. The end users 204 register on the platform and complete necessary identity verification. The platform collects required personal information securely. The end users 204 select their preferred currency and payment methods (e.g., bank transfer, credit/debit card) from the user interface module 206. The platform presents available currency-to-crypto providers based on the end user's 204 demographic or geographical region and user preferences.

The currency-to-cryptocurrency integration layer 208 interfaces with multiple fiat-to-crypto providers for processing fiat payments and purchasing the reference asset. The platform is designed with a flexible architecture to integrate multiple providers. A provider selection mechanism determines the optimal provider based on factors like fees, exchange rates, and availability. Upon confirmation of fiat payment, the platform automatically initiates the purchase of the reference asset (e.g., Bitcoin) from the selected provider. Real-time exchange rates are fetched to ensure accurate conversion.

The treasury management system 210 maintains the reference asset holdings equal to or exceeding the total tokens in circulation. All transactions are recorded on the platform's ledger, ensuring transparency and traceability. The treasury management system 210 transitions the treasury management to a decentralized model using blockchain technology for enhanced transparency.

The purchased reference asset is stored in a secure treasury wallet managed by the platform. The treasury holds assets equal to or exceeding the total BFD issued. The platform may provide users with verifiable proof of reserves. enhancing trust.

Redemption mechanism of the system 200 includes that users can request to redeem their BFD for the equivalent amount of the reference asset. The system 200 validates the request and deducts the corresponding BFD from the user's account.

Asset release includes the equivalent amount of the reference asset that is released from the treasury and transferred to the user's designated wallet. Smart contracts may govern the redemption process to ensure security and automation.

The security and compliance module 214 ensures customer identity verification, authorization, compliance, secure transactions, and regulatory adherence. Additional security checks may be performed to comply with regulations during redemption. Features of the security and compliance module include user account security that implements robust authentication methods (e.g., two-factor authentication). Options for biometric authentication and hardware security keys are available. Encryption of sensitive data and secure storage practices are features of the system 200.

Regulatory compliance: Adheres to financial regulations in applicable jurisdictions. Ongoing monitoring of regulatory changes to ensure continued compliance. The system 200 implements machine learning algorithms to detect and prevent fraudulent activities.

Provider interface module of the currency-to-cryptocurrency integration layer 208 include standardized Application Programming Interface (API)s allow easy integration with various fiat-to-crypto providers. The system can add or remove providers without disrupting platform functionality.

Provider selection logic of the currency-to-cryptocurrency integration layer 208 includes algorithms that determine the best provider for each transaction based on predefined criteria further enhances user experience by optimizing for cost, speed, and reliability. Platform integration and use of BFD is another feature of the currency-to-cryptocurrency integration layer 208.

Native currency functionality of the currency-to-cryptocurrency integration layer 208 includes BFD serves as the medium of exchange within the platform for various services and transactions and encourages a unified economy within the platform ecosystem.

Dynamic value representation of the currency-to-cryptocurrency integration layer 208 includes the value of BFD adjusts dynamically with the value of the reference asset. The end users 204 can track the real-time value of their BFD holdings.

The token issuance module 216 performs the calculation and issuance of tokens (e.g. BFD) to end users 204 based on the real-time value of the reference asset. The token issuance module 216 calculates the amount of the reference asset purchased. BFD is issued to the user's platform wallet based on the fixed ratio (for e.g., 1 BFD= 1/10,000th of a Bitcoin). Example: If a user purchases 0.01 BTC, they receive 100 BFD.

The token issuance module 216 performs the process of currency to cryptocurrency conversion, storage and redemption. The process begins with user registration.

User Registration and Payment: The end users 204 sign up on the platform using the user interface module 202 and provide necessary verification information. The users select a fiat payment method. and the platform connects to a fiat-to-crypto provider for processing. The platform supports a multi-layer provider model, which allows for future expansion beyond the initial provider (Moonpay®).

Real-Time Bitcoin Purchase: Once the fiat payment is confirmed, the platform initiates an automated purchase of Bitcoin from the selected provider. Real-time rates are fetched from the provider to ensure the most accurate conversion for the user. The platform performs internal calculations to ensure the value of the purchased Bitcoin aligns with the issuance of BFD.

BFD Token Issuance: The system 200 calculates how much Bitcoin has been purchased.

The corresponding amount of BFD, based on the fixed ratio of 1/10000 Bitcoin, is credited to the user's wallet. Example: If 0.01 BTC is bought, the system issues 1000 BFD (since 1 BFD= 1/10000 BTC).

### Bitcoin Treasury Management:

All Bitcoin purchased is stored in a dedicated treasury wallet.

The system ensures that the total Bitcoin in the treasury always equals or exceeds the total BFD issued, guaranteeing stability. The treasury operates on an automated smart contract-based system that locks Bitcoin and facilitates withdrawal only when BFD is redeemed.

BFD Redemption: In future iterations, users may redeem BFD for Bitcoin. Upon redemption, the system deducts the corresponding BFD from the user's account and releases the equivalent Bitcoin from the treasury. For example: If a user holds 1000 BFD, they can redeem it for 0.01 Bitcoin based on the fixed ratio.

### Advantages of the System 200—

### User-Friendly Conversion Process:

Simplifies the process of converting fiat to a digita1 currency usable within the platform.

### Enhanced Trust and Stability:

The treasury-backed system assures users that their digital currency is fully supported by real assets.

### Scalable and Flexible Architecture:

The ability to integrate multiple providers and adjust to different reference assets allows the platform to grow and adapt.

### Regulatory Compliance:

Built-in compliance measures facilitate operation in various jurisdictions, reducing legal risks.

It should be noted that all such aforementioned modules 206, 208, 210, and 214 may be represented as a single module or a combination of different modules. Further, as will be appreciated by those skilled in the art, each of the modules 206, 208, 210, and 214 may reside, in whole or in parts, on one device or multiple devices in communication with each other. In some embodiments, each of the modules 206, 208, 210, and 214 may be implemented as dedicated hardware circuit comprising custom application-specific integrated circuit (ASIC) or gate arrays, off-the-shelf semiconductors such as logic chips, transistors, or other discrete components. Each of the modules 206, 208, 210, and 214 may also be implemented in a programmable hardware device such as a field programmable gate array (FPGA), programmable array logic, programmable logic device, and so forth. Alternatively, each of the modules 206, 208, 210, and 214 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for dynamically maintaining a creator-linked digital asset platform. For example, the exemplary system 100 and the associated server 102 may dynamically maintain a creator-linked digital asset platform by the processes discussed herein. In particular, as will be appreciated by those of ordinary skill in the art, control logic and/or automated routines for performing the techniques and steps described herein may be implemented by the system 100 and the associated server 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

Referring to FIG. 2B, illustrates a flow diagram 200-1 of the system 200 according to an embodiment of the present disclosure. In one embodiment, the flow diagram 200-1 of the system 200 includes an overview of the system 200. The flow diagram 200-1 includes a payment system 218, a crypto-currency receiver wallet 220, tax fees 222, a community chest 224, custodial wallet(s) 226, currency band account 228, and customers 230 (including customers 230-1, 230-2, 230-3, . . . , 230-n). The payment system 218 includes digital wallets, payment gateways, coins, cards, and other payment mediums. The payment methods enable the customers 230 to make payments for purchasing the items. The currency can be in fiat currency like dollar, rupees, etc.

The crypto-currency receiver wallet 220 receives the cryptocurrency from the customers. The crypto-currency receiver wallet 220 is a digital repository for storing the transactions from the users. The crypto-currency receiver wallet 220 receives the payments made by the customers 230 using the payment system 218. The crypto-currency receiver wallet 220 provides translates the transactions into coins and provides it to the community chest 224. The crypto-currency receiver wallet 220 includes fiat to cryptocurrency (bitcoin) conversion and the BlackFlame Dollar (BFD) conversion. The BFD conversion is processed as coins.

The tax fees 222 is a digital repository for storing the taxes for the transactions by the customers 230. The taxes are calculated based on the conditions of transactions. The tax may be applicable on the transactions.

The community chest 224 collects a percentage of all coins received from the crypto-currency receiver wallet 220 bought and sold on the platform. The accumulated value is then distributed daily among the customers 230 who hold the coins, based on their proportional holdings. The community chest 224 provides the coins to the custodial wallets 226.

The custodial wallets 226 is also a storage for coins facilitating easy and ready access for the customers 230. The custodial wallets 226 receives the coins from the community chest 224. The processed coins or the BFD amount can be accessed by the customers 230 from the custodial wallets 226.

The currency band account 228 holds account details of the customers 230. The customer accounts are used for making transactions. The taxes applicable on the transactions are processed by the tax fees 222.

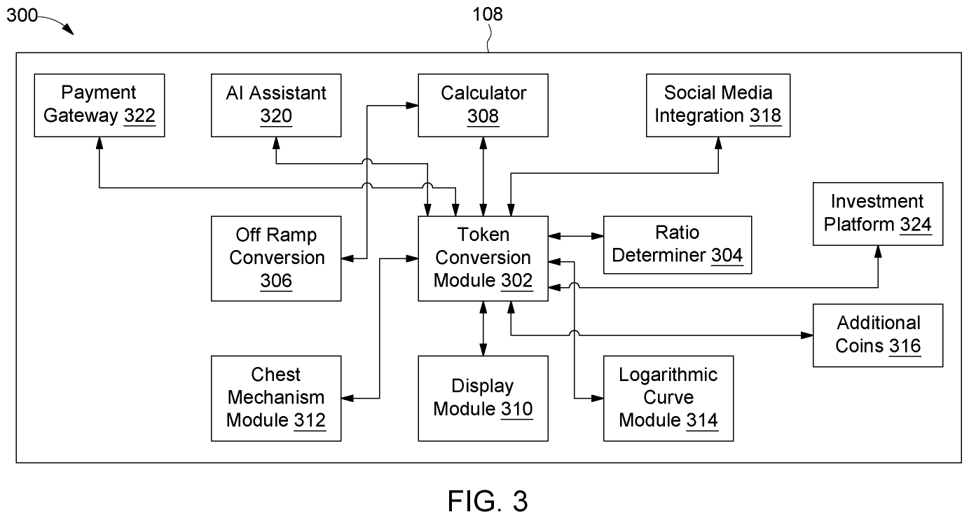

Referring to FIG. 3, illustrates a block diagram 300 of the currency-to-cryptocurrency integration layer 208 according to an embodiment of the present disclosure. In one embodiment, the block diagram 300 includes a token conversion module 302, a ratio determiner 304, an off ramp conversion 306, a calculator 308, a display module 310, a chest mechanism module 312, a logarithmic curve module 314, additional coins 316, a social media integration 318, an artificial intelligence (AI) assistant 320, a payment gateway 322, and an investment platform 324, which are communicatively coupled with one another.

In some embodiments, the token conversion module 302 converts the currency such as fiat (USD, EURO, Rupee) into a cryptocurrency like bitcoin and then to a token (BFD) using the ratio determiner 304, and the calculator 308. The amount of token or BFD is displayed to the end user 204 using the display module 310. The ratio determiner 304 determines the ratio for conversion to cryptocurrency or bitcoin. The calculator 308 determines the BFD value by calculating the BFD amount using the ratio determined by the ratio determiner 304.

An end user 204 having BFD initiates a request to convert it back into either fiat currency or bitcoin. If the user opts for bitcoin, they input their wallet address. If they choose fiat, the platform handles the conversion through an integrated crypto-to-fiat provider. The end user 204 has two options-Option
Option 1: Fiat Conversion: The platform uses a crypto-to-fiat provider to convert the user's BFD into Bitcoin, which is then sold, and the fiat equivalent is transferred to the user's account.
Option 2: Direct Bitcoin: The user can provide their Bitcoin wallet address, and the platform transfers Bitcoin directly to that wallet, based on the pegged value of BFD.

The off ramp conversion 306 allows the conversion of the BlackFlame® Dollar (BFD) either into fiat currency or directly into bitcoin. The end users 204 can choose between receiving fiat via a third-party provider or transferring the bitcoin to their own digital wallet, giving them flexibility in terms of cash out. The user selects their preferred method (fiat or Bitcoin), the platform converts the required amount of BFD into Bitcoin.

Real-Time Calculation: The platform calculates the exact Bitcoin amount based on the fixed peg (1 BFD= 1/10000 Bitcoin).

Bitcoin Transfer: If the user requests Bitcoin, it is transferred directly from the treasury to the wallet address they provided.

If the end user 204 opts for fiat, the platform sells the Bitcoin through the integrated crypto-to-fiat provider (starting with Coinbase but expandable to others). The fiat: equivalent is transferred to the user's bank or payment account. For example: If a user wants to convert 1000 BFD, the system converts it to 0.1 Bitcoin. That 0.1 Bitcoin is sold through the provider, and the user receives the corresponding fiat amount. The platform charges a small fee for off-ramp conversions, which could be either in BFD or as a percentage of the fiat or Bitcoin transfer, depending on the integration with providers.

The end user 204 initiates off ramp request to receive the BFD amount in bitcoin or fiat. The end user 204 logs into the platform of the system 200, selects the off-ramp option, and chooses either fiat conversion or direct Bitcoin transfer. The platform retrieves real-time Bitcoin prices and calculates the equivalent value using the ration determiner 304 for the BFD they wish to convert.

The end user 204 selects payout option from fiat option or Bitcoin option.

Fiat Option: The user selects the fiat conversion option, and the platform connects with a crypto-to-fiat provider to convert BFD into Bitcoin, sell it, and deposit fiat into the user's account.

Bitcoin Option: The user enters their Bitcoin wallet address, and the platform initiates a transfer from the treasury directly to that wallet.

The token conversion module 302 performs real-time BFD to bitcoin conversion. The system calculates the equivalent amount of Bitcoin for the user's BFD at the fixed peg (1 BFD= 1/10000 BTC). The BFD is deducted from the user's wallet, and the system transfers the Bitcoin either to the user's wallet (for Bitcoin) or to the exchange for fiat conversion.

### Completion of Fiat or Bitcoin Transfer:

Fiat Transfer: The platform sells the Bitcoin via the integrated provider (Moonpay® or others) and transfers the equivalent fiat to the user's bank account or wallet.

Bitcoin Transfer: If the user opted for direct Bitcoin, the exact amount of Bitcoin is sent to their provided wallet address.

The off-ramp is designed with flexibility to integrate with multiple crypto-to-fiat providers, allowing the platform to scale as new providers are added. The bitcoin transfer option provides an alternative to the crypto-to-fiat off-ramp, offering users direct control over their funds.

Dual Off-Ramp System: A proprietary system offering users the option to convert BFD either into fiat via a crypto-to-fiat provider or directly into Bitcoin by providing a wallet address.

Real-Time BFD to Bitcoin Conversion: A dynamic, real-time system that calculates the exact Bitcoin value of BFD based on a fixed peg and initiates the appropriate transaction (either direct Bitcoin transfer or fiat sale).

Multi-Provider Crypto-to-Fiat Integration: A flexible off-ramp mechanism capable of integrating with multiple crypto-to-fiat providers, allowing seamless expansion as new providers are added.

Direct Bitcoin Transfer Feature: A unique feature where users can choose to receive their Bitcoin directly into their personal wallets, bypassing the crypto-to-fiat conversion process.

The chest mechanism module 312 collects a percentage of all coins bought and sold on the platform. The accumulated value is then distributed daily among end users 204 who hold the coins, based on their proportional holdings. The chest refills every 24 hours, ensuring ongoing rewards for active participants. If end users 204 do not claim their rewards on a given day, they do not accumulate further, and the chest stops accruing until the next day's transactions.

The logarithmic curve module 314 is a pricing mechanism used for all coins on the platform. It determines how the price of a coin increases as more of that coin is purchased. The additional coins 316 are a repository of the coins maintained in a data storage. The social media integration 318 allows users to create coins on the platform using their social media profiles. The AI assistant 320 replicates a user's voice and provides guidance within a platform of the system 200. The payment module 322 provides a payment gateway for the user coins. The investment platform 324 performs aggregating social media content into a centralized, dynamic timeline within a user investment platform, enhancing user engagement by integrating social activities with trading interactions. The functionality of the different modules is explained in detail in the coming figures.

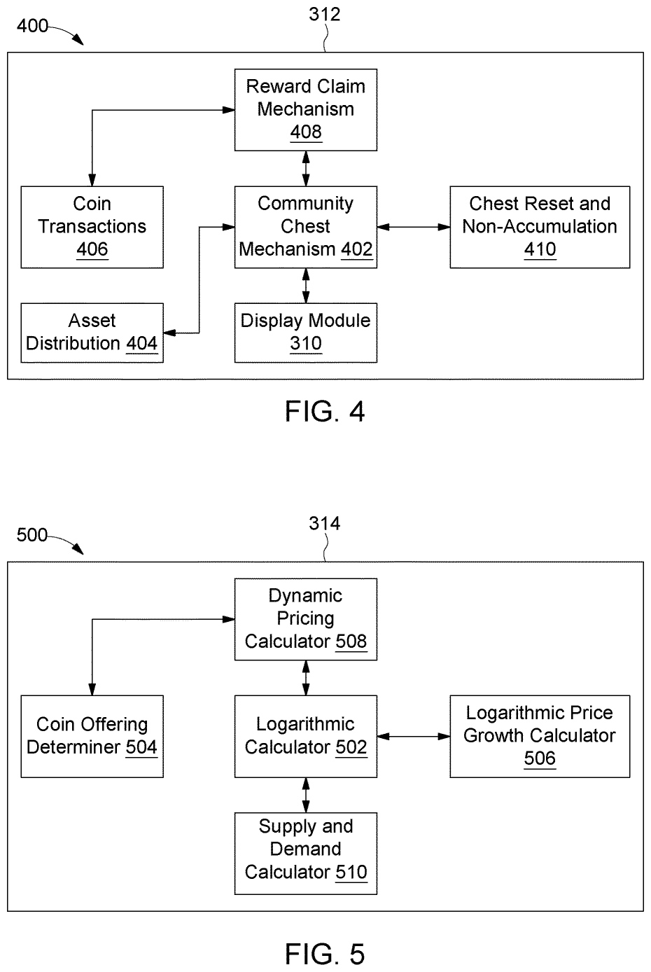

Referring to FIG. 4, illustrates a block diagram 400 of the chest mechanism module 312 according to an embodiment of the present disclosure. The chest mechanism module 312 includes a community chest mechanism 402, an asset distribution 404, coin transactions 406, a reward claim mechanism 408, and a chest reset and non-accumulation 410.

The chest mechanism module 312 relates to digital trading platforms and reward distribution systems, specifically to a method and system for dynamically collecting and distributing transaction-based rewards to users based on their proportional holdings and active participation.

Existing trading platforms often lack incentives that: promote active participation and fair reward distribution among users. Users may not be sufficiently encouraged to engage regularly with the platform, leading to decreased activity and retention. Some platforms offer static reward systems or dividends, but they may not dynamically reflect trading activity or incentivize daily engagement. There is a need for a system that fairly distributes rewards based on both user holdings and active participation.

A mechanism that ties rewards directly to trading activity and user engagement can enhance user experience and platform activity. Encouraging daily participation through a non-accumulating reward system promotes consistent user interaction.

The community chest mechanism 402 is where a percentage of all coin transactions (buying and selling) on the platform is collected into individual community chests for each coin. The accumulated value in each chest is distributed daily to users holding that specific coin, based on their proportional ownership. The system resets the chest every 24 hours, and users must claim their rewards daily; otherwise, rewards stop accumulating for them until they reactivate by trading or claiming. This mechanism incentivizes users to engage with the platform regularly and promotes fair distribution of rewards based on both investment and activity.

A portion of the transaction fees collected for every ‘buy’ action on a creator's coin is deposited directly into the creator's community chest. This ensures that creators benefit proportionally from the trading activity of their coins while maintaining alignment with the existing community chest distribution framework.

### Process Components:

### Fee Division:

When a transaction occurs involving a creator's coin, a portion of the transaction fee (e.g., X%) is allocated to the creator's community chest.

This allocation happens alongside the usual percentage going to the general community chest for the coin holders and the platform treasury.

### Earnings Flow:

Fees directed to the creator's community chest.

### Transaction Fee Allocation:

### When a Coin is Bought:

A percentage of the fee is routed to the creator's community chest.

Remaining fees are allocated as per standard chest and treasury distribution.

### Creator Engagement:

Creators are notified of daily rewards to encourage ongoing platform interaction.

Transparency ensures creators understand their earnings are tied directly to trading activity.

### Key Features of the Chest Mechanism Module 312:

Dynamic Coin-Based Community Chest: Each coin has its own chest that grows with the coin's trading activity.

Proportional Daily Reward Distribution: Rewards are distributed based on the percentage of total coins a user holds.

Non-Accumulation for Inactive Users: Rewards stop accumulating for users who do not claim daily, encouraging active participation.

Daily Reset and Refill Mechanism: The chest resets every 24 hours, ensuring ongoing incentives and time-sensitive engagement.

The asset distribution 404 performs daily distribution of coins. Once per day, the contents of the chest are distributed among the holders of that coin in proportion to their holdings. Users who own more of the coin receive a larger portion of the chest. If a user holds 10% of the total circulating supply of a specific coin, they receive 10% of that coin's community chest rewards for the day by the asset distribution 404.

The coin transactions 406 stores the coin transactions performed by the end user 204 in chests (for example, a digital storage). Every time a user buys or sells a coin, a small percentage of the transaction value is added to the Community Chest. Each coin has its own community chest, shared among holders of that specific coin. For example, if an end user 204 buys 100 coins of a particular coin, 2% (or whatever set percentage) of the transaction value in BFD goes into the community chest of that coin. The coin being associated with payments by the end user 204.

The reward claim mechanism 408 enables the end users 204 to claim their community chest rewards daily by logging into the platform of the system 200. The claim process is automated, and users simply confirm their rewards to have them transferred to their wallets in BFD.

The chest reset and non-accumulation 410 resets the chest. After each day's distribution, the chest is reset. Users must claim their rewards before the chest is reset. If they fail to do so, the rewards do not accumulate, and the chest stops accruing new rewards for those users until they make another trade or claim. For example: If a user does not claim their rewards for the day, they lose out on that day's community chest allocation, and it does not carry over to the next day.

Auto-Claim Option of the chest mechanism module 312: In future iterations, there may be an option for users to set up an automatic daily claim, ensuring they don't miss out on rewards.

The community chest mechanism 402 performs the control of the components of the chest mechanism module 312. The community chest mechanism 402 performs transaction fee accumulation.

Transaction fee accumulation: Every time a coin is bought or sold, a percentage of the transaction (determined by platform rules) is added to the community chest specific to that coin. The percentage of the transaction fee that goes into the chest can vary depending on the coin, but the concept remains consistent: each coin's chest grows as it is actively traded.

Mechanism: A predefined percentage of each coin transaction is diverted into that coin's community chest. The percentage may vary per coin but is consistently applied across all transactions for that coin. Example: A 2% fee from a transaction of 100 units of Coin X results in 2 units' worth being added to coin X's community chest.

Proportional reward distribution: Once every 24 hours, the community chest mechanism 402 calculates how much each user is entitled to based on their holdings of the specific coin. Users receive their rewards in proportion to their total coin ownership (i.e., if they hold 10% of all issued coins, they receive 10% of that coin's daily chest rewards).

### Calculation:

At a set time every 24 hours, the system calculates each user's share of the community chest based on their coin holdings.

Formula: User Reward=(User's Coin Holdings/Total Circulating Supply of Coin)

### Total Chest Value

Distribution: Rewards are allocated in the platform's native currency (e.g., BFD).

Users with larger holdings receive proportionally larger rewards.

### Non-Claim Consequences:

Users must manually claim their rewards from the community chest each day.

If a user does not claim their rewards, the chest stops accumulating for that user, and they do not receive retroactive rewards for missed days. Only active participants benefit from daily claims.

Reset Process: The community chest resets at the end of each day, ensuring that rewards are distributed on a regular basis without lingering or accumulating indefinitely.

### Claim Process:

The platform will provide a simple dashboard or interface where users can see their community chest rewards for each coin they hold.

Users will be prompted to claim their rewards daily. Once claimed, the BFD rewards are transferred to their wallet automatically.

Claim Requirement: Users must manually claim their rewards daily through the platform interface.

### Consequence of Non-Claim:

If a user does not claim their rewards before the chest resets, they forfeit those rewards. Additionally, the chest stops accruing new rewards for that user until they either make a new trade involving that coin or manually claim.

Purpose: Encourages daily platform engagement and active participation.

Future Automation: An optional automated claim feature may allow users to set up auto-claim, so they never miss a daily reward.

### Daily Reset and Refill Mechanism

### Reset Process:

After rewards distribution, each community chest is reset to zero.

### Refill Mechanism:

As new transactions occur, the chest begins to accumulate funds again based on the transaction fee percentage.

### Timing:

The 24-hour cycle ensures predictability and regularity in reward distribution.

### Reward Claim Process

User Interface: Users access a dashboard displaying their eligible rewards for each coin held.

Claiming Rewards: Users confirm the claim action to have rewards transferred to their wallets.

Future Auto-Claim Option: An opt-in feature allowing users to automatically claim rewards daily.

Provides convenience and ensures users do not miss out on rewards.

### Advantages of the Chest Mechanism Module 312:

Dynamic Coin-Based Community Chest: A system where each coin has its own community chest that grows as the coin is traded, ensuring the chest reflects the tracking activity of each individual coin.

Proportional Daily Reward Distribution: A method for distributing rewards from the community chest to users based on the percentage of total coins they own, ensuring fair distribution among active participants.

Non-Accumulation for Inactive Users: A unique feature where rewards stop accumulating if users do not claim them daily, promoting active engagement and participation on the platform.

Daily Reset and Refill Mechanism: The chest resets every 24 hours, with rewards distributed to active participants only, ensuring ongoing, time-sensitive incentives for users to engage with the platform.

Promotes Active Engagement: Encourages users to interact with the platform daily to claim rewards.

Fair Reward Distribution: Rewards are proportionally distributed based on actual holdings, ensuring fairness.

Dynamic Incentivization: The accumulation and distribution of rewards reflect real-time trading activity.

Prevents Reward Boarding: Non-accumulation for inactive users prevents indefinite buildup of unclaimed rewards.

Enhances Platform Activity: The mechanism stimulates consistent trading and platform usage.

Therefore, the invention presents a novel system for integrating a dynamic reward mechanism within a digital trading platform. By tying rewards to both trading activity and user engagement, it creates a self-sustaining ecosystem that benefits active participants and enhances overall platform vitality.

### Potential Modifications Include:

Variable Claim Periods: Adjusting the claim window from daily to other intervals (e.g., weekly) while maintaining the non-accumulation principle.

Tiered Reward Systems: Introducing tiers where users with higher engagement levels receive additional benefits.

Community Governance: Allowing users to vote on the transaction fee percentages or reward distribution methods.

### Implementation Considerations

Technical Infrastructure: The system can be implemented using blockchain technology for transparency and security. Smart contracts could automate the accumulation, distribution, and reset processes.

Security Measures: Implementing robust authentication to secure user accounts and wallets. Regular audits to ensure the integrity of the reward distribution mechanism.

Regulatory Compliance: Ensuring adherence to financial regulations regarding reward distributions and transaction fees. Providing clear terms and conditions outlining the reward system to users.

Referring to FIG. 5, illustrates a block diagram 500 of the logarithmic curve module 314 according to an embodiment of the present disclosure. The logarithmic curve module 314 is a pricing mechanism used for all coins on the platform. It determines how the price of a coin increases as more of that coin is purchased. Each user coin represents an individual's unique value within the BlackFlame ecosystem. Instead of traditional stocks or shares, the individual users's stock are referred as coins. These coins are priced in BFD (BlackFlame Dollar).

The logarithmic bonding curve provides a mint and burn mechanism for creating and destroying coins based on market activity. Coins are minted when purchased, and their price increases logarithmically as the supply grows. Conversely, coins are burned when sold, reducing the supply and lowering the price.

### Dynamic Pricing with Logarithmic Bonding Curve

### Pricing Formula:

As more coins are minted (higher demand), the price increases at a decreasing rate (logarithmic nature), creating scarcity and incentivizing early investment.

Selling coins burns them, reducing supply and rebalancing prices downward.

Key Benefits of the dynamic pricing with logarithmic bonding curve include:

### Fair Market Discovery:

Pricing reflects organic demand for an individual's coin.

### Scalability:

Logarithmic curves prevent runaway inflation in coin prices while maintaining growth incentives.

### Sustainability:

Burned coins remove excess supply, stabilizing the market and avoiding oversaturation.

### Mint and Burn Dynamics

### Minting Process (Purchase):

When a user buys a coin, it is minted directly into circulation.

The buyer pays in BFD, which is locked in the treasury and distributed as Community Chest rewards.

### Burning Process (Sale):

Selling a coin triggers a burn mechanism:

The coin is removed from circulation.

The seller is compensated in BFD based on the current price along the curve.

### Differentiator Value

This system ensures everyone's value is dynamic, fair, and transparent, unlike traditional stocks with fixed parameters.

### Deflationary Economy:

The burning mechanism reduces supply, ensuring value increases for long-term holders.

### Rewarding Early Adoption:

Early supporters benefit from lower initial prices and exponential growth as demand rises.

The curve ensures that early buyers get lower prices, while later buyers face higher prices due to the increasing demand. The pricing of all coins is done in BlackFlame® Dollar (BFD), and the logarithmic curve regulates the price growth as the coin's supply increases.

The logarithmic curve module 314 includes a logarithmic calculator 502, a coin offering determiner 504, a logarithmic price growth calculator 506, a dynamic pricing calculator 508, and a supply and demand calculator 510.

The logarithmic calculator 502 determines the increase in the price of a coin as the purchase of the coin is increased. The increase is captured in the form of a logarithmic curve. The logarithmic calculator 502 receives the information processed by the coin offering determiner 504, the logarithmic price growth calculator 506, the dynamic pricing calculator 508, and the supply and demand calculator 510 to calculate the logarithmic price curve.

When a coin is created, it is given an initial base price in BFD. This base price is the lowest price the coin will ever be sold at, and from this point forward, the price will only increase as more units are sold. Each coin starts at an initial base price in BFD, set by the creator or the platform. This base price is the lowest possible price for the coin, and as more of the coin is purchased, the price increases according to a logarithmic bonding curve. For example: A coin starts at 1 BFD per unit. As more users buy it, the price increases along the logarithmic curve.

The coin offering determiner 504 calculates the amount of the coin that can be offered to the users. The amount is calculated based on the real time offering available in market and algorithms are used to calculate the offering.

The logarithmic price growth calculator 506 determines the increase in the price and the coins. As the number of coins in circulation grows, the price increases more slowly compared to a linear or exponential curve. This means the price rises rapidly at first but eventually flattens out, making large jumps in price harder to achieve as more of the coin is purchased. For example: Early buyers might see the price increase from 1 BFD to 5 BFD quickly. However, as more coins are sold, the price might only increase from 5 BFD to 6 BFD, even with a significant number of new buyers.

Every time a user purchases a coin, the logarithmic price growth calculator 506 calculates the new price of the coin based on the number of units currently in circulation. The logarithmic curve is applied, which causes the price to rise quickly at first and then slow down as the number of circulating coins increases. Algorithmic adjustment of the logarithmic price growth calculator 506 involves the pricing algorithm ensures that the price increases proportionally to the demand but flattens as the supply grows to maintain affordability at higher volumes.

The dynamic pricing calculator 508 executes a pricing algorithm. The pricing algorithm is dynamic and automatically adjusts the price based on the number of coins sold. Each new purchase moves the price slightly up the curve, while each sale can move the price down the curve, though the decrease is not as rapid. For example: If many users start buying a specific coin, the price will rise rapidly at first, then slow down as the number of purchases increases. If users sell the coin, the price can decrease, but at a more moderated rate.

If users sell their coins, the price can decrease slightly. However, due to the nature of the logarithmic curve, price drops are much slower than price increases. For example, if a coin's price increases from l BFD to 5 BFD quickly during a buying spree, the price may only drop to 4.5 BFD if users start selling their coins.

The logarithmic bonding curve ensures that as more coins are minted (created and sold), the price increases more slowly, allowing for larger supplies without runaway price inflation. For example: If a coin's initial price is set at I BFD for the first 100 units, as the number of units increases to 1000, the price might stabilize at around 10 BFD due to the curve flattening.

The supply and demand calculator 510 identifies demand of coins among the users and the number of coins available on the treasury.

The display module 310 provides a real-time price display to end users/users 204. The platform shows users the real-time price of each coin based on the current supply and demand, with pricing adjustments occurring after each transaction. Users can see how the price changes over time, allowing them to make informed decisions about when to buy or sell.

### Key Features of the Logarithmic Curve Module 314—

Logarithmic Bonding Curve Algorithm: A proprietary pricing algorithm that applies a logarithmic curve to determine the price of coins based on the number of units sold. The curve ensures rapid price increases initially, followed by slower growth as supply increases.

Dynamic Price Adjustment: A real-time, automatic price adjustment system that updates the price of a coin after every transaction based on supply and demand, ensuring fairness for early and late buyers alike.

Supply and Demand Moderation: A unique mechanism that moderates price increases, preventing excessive inflation for coins with high supply by flattening the price curve at higher quantities.

Price Stability for High Volume Coins: A feature that ensures coins with larger volumes experience smaller price increases, allowing more users to access the coin without drastic price inflation.

Real-Time Price Transparency: A system that shows users the current price of a coin, updated in real time after each transaction, giving full transparency into the pricing dynamics.

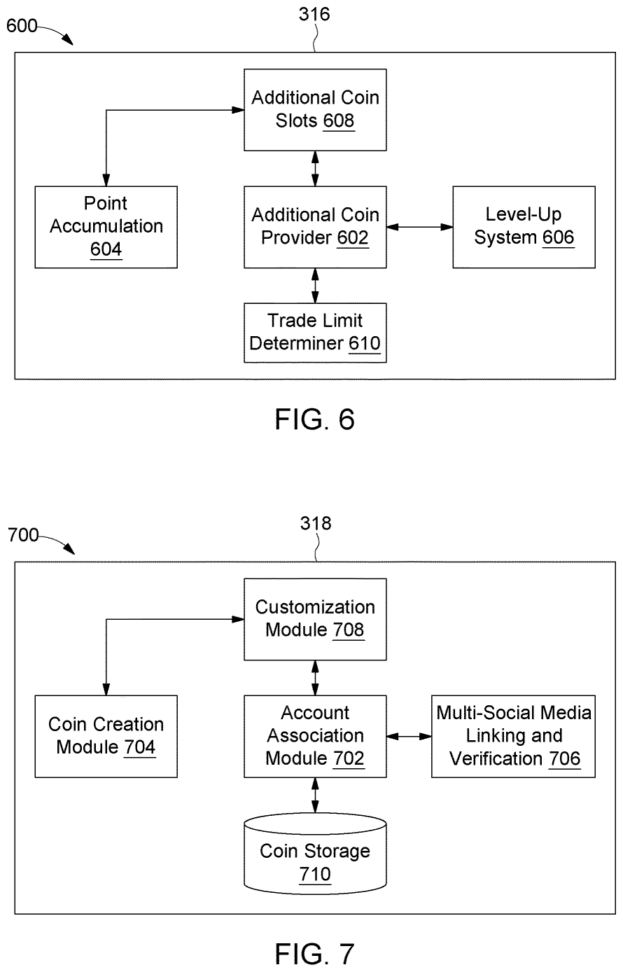

Referring to FIG. 6, illustrates a block diagram 600 of the additional coins 316 according to an embodiment of the present disclosure. The additional coins are a repository of the coins maintained in a data storage. The additional coins 316 includes an additional coin provider 602, a point accumulation 604, a level-up system 606, additional coin slots 608, and a trade limit determiner 610.

Traditional digital trading platforms often lack engaging interfaces and strategic investment limitations that promote user interaction and thoughtful decision-making. There is a need for an innovative system that combines an intuitive, user-friendly interface with strategic investment mechanics to enhance user engagement and provide a novel trading experience.

The platform provided by the system 200 enables users to purchase stock coins of other users and their own using the additional coins 316. The interface is designed to resemble a streaming service's browsing experience, presenting each user's stock in a catalog format for easy exploration. When a stock coin is purchased, it is allocated to one of the user's available slots. Each slot is dedicated to a specific user's stock. Within each filled slot, users can purchase multiple coins of that particular stock without occupying additional slots. The number of available slots is limited, adding a strategic layer as users must choose which user stocks to invest in carefully. This system enhances user engagement by combining familiar browsing experiences with strategic investment limitations, encouraging users to make thoughtful decisions about their investments.

This introduces a novel system and method for our user-driven stock coin trading platform that enhances user engagement through an intuitive interface and strategic investment limitations. By limiting the number of available slots for different stocks and allowing unlimited purchases within each slot, users are encouraged to make thoughtful investment choices, thereby creating a more engaging and dynamic trading experience.

The user interface module 206 mimics a streaming service's browsing experience, displaying user stocks in a catalog format with options for sorting and filtering. Users log in to the platform and access a visually engaging interface that displays user stocks similarly to how movies or shows are presented on a streaming service. Each stock entry includes information about the user, stock performance, and options to purchase.

The additional coin provider 602 communicates with the other components of the additional coins 316 to identify additional coins for the end users 204. The additional coin provider 602 performs a level-up feature. The coin slots with level-up feature allow users to unlock additional coin slots and increase the number of trades they can make as they progress through the platform. Users gain Experience Points (XP) by engaging in trading activities. As they accumulate XP, they unlock new coin slots, which enable them to hold or trade more coins simultaneously. Additionally, their daily trade limit increases as they level up, rewarding active participation and long-term engagement. The additional coin provider 602 includes various modules that perform the tasks for coin accumulation and management. The modules include—

Stock Coin Management Module: Handles the creation, purchase, and sale of stock coins.

Slot Allocation Module: Manages the allocation of purchased stock coins into the user's limited available slots.

Strategic Investment Mechanism: Enforces slot limitations to introduce strategic decision making in investment choices.

When a user decides to purchase a stock coin:

The user selects the desired stock from the catalog.

The system checks for an available slot. If a slot is available, the stock coin is allocated to that slot. If the stock already occupies a slot, additional coins can be purchased without using extra slots. If no slots are available, the user must free up a slot by selling a stock or choose not to proceed.

### Slot Mechanics:

Limited Slots: Users have a μredefined number of slots (e.g., five slots) to allocate different user stocks.

Slot Representation: Each slot visually represents the stock it holds, displaying relevant information and purchase options.

Strategic Element: The slot limitation requires users to prioritize their investments, adding a strategic layer to the trading experience.

### Managing Stocks Within Slots

Purchasing More Coins: Users can buy additional coins of a stock already in a slot without affecting other slots.

Selling Stocks: Users can sell coins from a slot. If all coins of a stock are sold, the slot becomes available for a new stock.

Slot Expansion: While not the focus here, the system may allow users to unlock additional slots through certain achievements or purchases.

Users earn XP for every trade they make. The XP awarded is determined by the trade size, frequency of trading, or specific events on the platform. The platform can implement dynamic XP rewards, where users earn extra XP for certain types of trades (e.g., larger trades or trading during high-traffic periods).

The point accumulation 604 performs XP Accumulation: Users earn Experience Points (XP) for each trade they make on the platform. The amount of XP earned can vary based on the value or volume of the trade, incentivizing more active participation. XP Calculation: XP is calculated based on various factors such as the size of the trade (larger trades earn more XP) and certain milestones like consecutive trading days.

As users accumulate XP, they reach new levels. Each level unlocks new features, primarily additional coin slots and higher daily trade limits. The level-up progression system is structured to reward active traders without overwhelming new users, allowing for gradual growth in engagement.

The level-up system 606 enables users to unlock new levels. As users accumulate XP. they unlock new levels. Each new level grants the users additional perks, the primary benefit being the ability to unlock more coin slots. Coin slots represent how many different coins (or types of coins) a user can hold or trade simultaneously. At the beginning, users have access to a limited number of slots, but as they level up, they unlock more slots.

Unlocking coin slots: When a user reaches a new level, they are granted the ability to unlock more coin slots, allowing them to bold or trade a larger variety of coins simultaneously.

Coin slot Expansion: The system ensures that the number of unlocked slots increases incrementally with each level, providing a controlled expansion of the user's capacity. For example: At Level 1, users may have 5 slots. Upon reaching Level 5, they can have 10 slots, allowing them to engage with more coins.

The additional coin slots 608 determines additional coin slots for the users. When the users level up, they gain the ability to unlock additional coin slots, allowing them to diversify their holdings or engage with more coins on the platform. For example: A user starts with 5 coin slots. After reaching a new level by earning enough XP, they unlock 2 additional coin slots, allowing them to hold up to 7 different coins.

### Increasing Daily Trade Limit:

The daily trade limit increases as users level up. This gives higher-level users an advantage, as they can execute more trades within a day compared to lower-level users. For example: A user starts with a daily limit of 10 trades. After leveling up, this limit increases to 20, providing them with more flexibility and opportunities for trading.

The trade limit determiner 610 determines daily trade limits for the users. Along with unlocking more coin slots, users also receive an increase in the number of trades they can make each day. This daily trade limit grows as users level up, rewarding active traders. For example: A user may initially have a limit of 10 trades per day. As they level up, this limit increases to 20 trades per day, allowing them to engage in more market activity.

User Dashboard and Progress Tracking: Users can track their XP, levels, and available coin slots via a personalized dashboard. The platform provides a visual progress tracker, showing how much XP is needed to reach the next level and the benefits unlocked at each level (such as new coin slots or increased trade limits).

Future Iterations and XP Milestones: Certain XP milestones could unlock unique bonuses or achievements, such as temporary boosts to trading limits or special access to platform events. However, these features can be introduced in future iterations. Future versions of the system could introduce additional XP milestones that reward users with temporary bonuses, such as access to exclusive platform features or temporary boosts in trade limits.

### Key Features of the Additional Coins 316—

XP-Based Level-Up System: A dynamic system where users earn XP through trading activities and level up, unlocking new features such as additional coin slots and higher trade limits.

Coin Slot Unlock Mechanism: A proprietary system where users can unlock additional coin slots as they level up, allowing them to trade or hold more coins simultaneously.

Increased Daily Trade Limits Based on Level: A unique reward mechanism that increases the daily trade limit for users as they reach higher levels, encouraging active participation and sustained engagement on the platform.

Progress Tracking and Visualization: A visual dashboard that tracks user progress, showing their XP, levels, available coin slots, and trade limits in real-time.

### Advantages of the Invention

Enhanced User Experience: By emulating a familiar streaming service interface, users find it intuitive and engaging to browse and select stocks.

Strategic Investment Decisions: The limited slot system requires users to prioritize their investments, fostering deeper engagement and thoughtful decision-making.

Scalable Investment Management: Allowing multiple purchases within a single slot for a specific stock simplifies portfolio management and reduces complexity.

Innovative Trading Mechanics: Combining traditional trading with gamified elements creates a unique platform that stands out in the market.

### Potential Modifications and Embodiments

Slot Expansion Mechanisms: Users may unlock additional slots through increased activity, subscription tiers, or in-platform achievements.

Social Features: Integration of social elements such as following other users, sharing investment strategies, or collaborative investing, although not essential to the core invention.

Advanced Analytics: Providing users with data analytics and insights on stock performance to aid in strategic decision-making.

Referring to FIG. 7, illustrates a block diagram 700 of the social media integration 318 according to an embodiment of the present disclosure. The additional coins 316 are a repository of the coins maintained in a data storage. The social media integration 318 includes an account association module 702, a coin creation module 704, a multi-social media linking and verification 706, a customization module 708, and a coin storage 710.

The social media integration 318 allows users to create coins on the platform using their social media profiles. The profile photo from the user's social media account is used as the coin's image, and their handle becomes the coin's name. Additionally, users can link multiple social media accounts for verification purposes, with clickable logos of these platforms displayed on their coin's profile, enabling viewers to verify the authenticity of the coin's creator.

The account association module 702 facilitates sign-in with the social media account of the users. The users can sign into the platform using their social media accounts (e.g., Twitter®, Facebook®, Instagram®). This integration serves two purposes, ease of access for the user and the automatic creation of a coin linked to their social profile. The integration includes user authorization. The authorization may include OAuth Integration where the platform of the system 200 uses OAuth to allow users to securely log in with their social media credentials, streamlining the registration and coin creation process.

### OAuth-Based Social Media Login:

Users log into the platform using their social media accounts (e.g., Twitter®, Facebook®, Instagram®) through OAuth, allowing secure, one-click access.

Streamlined Registration and Coin Creation: The platform uses the user's social media credentials to automatically generate a coin on their behalf, simplifying the onboarding process.

The coin creation module 704 creates a profile for the coin.

Coin creation using profile data: Upon signing in, a coin is automatically created using the user's social media data:

Coin Name: The user's social media handle (e.g., @username) becomes the name of the coin.

Profile Picture as Coin Image: The user's profile picture from their social media account is used as the coin's image. Example: A user signing in with their Twitch account “example” will have a coin named “example” with their Twitter® profile picture as the coin's image.

### Coin Creation via Social Media Profile:

The user's social media handle becomes the coin name, and their profile picture is used as the coin image.

Automated Coin Creation: A proprietary system automatically generates coins for users based on their social media profile data, reducing the manual effort required for coin creation. Example: User ‘johnsmith’ logs in with Facebook®. A coin named ‘johnsmith’ with their Facebook® profile picture is created instantly.

The multi-social media linking and verification 706 provides multiple social media profile links of the users. The users can link multiple social media accounts to their coin for enhanced verification. The logos of these platforms appear on the coin's profile, and each logo is clickable, leading directly to the respective social media account.

Verification Logos: Social media logos (e.g., Twitter®, Instagram®) appear on the user's coin profile, and viewers can click on these logos to be redirected to the user's verified accounts. For example: A user links their Instagram®, Twitter®, and Facebook® accounts. Their coin profile will display clickable logos for all three accounts, verifying the user's identity.

Users can link additional social media accounts to their profile. The platform displays clickable logos for each linked social media platform, allowing viewers to verify the authenticity of the coin creator.

Verification Process: The social media logos appear on the coin's profile page, and each logo links directly to the respective account, ensuring that the creator's identity is easily verified.

The customization module 708 enables the users to customize profile pictures, names, etc. While the coin's name and image are automatically set to the user's social media handle and profile picture upon creation, future versions of the platform will allow users to customize these elements:

Custom Coin Image: Users will be able to upload a custom image to replace their social media profile picture as the coin image.

Custom Coin Name: Users will be able to modify the coin's name, giving them more creative control over their coin's branding.

Users will have the option to customize their coins by uploading a new image or changing the coin name in future iterations of the platform.

Editable Coin Features: Users will be able to change the default social media generated, coin name and profile picture, providing greater flexibility and creative control over the coin's presentation.

The coin profiles corresponding to the users are stored in the coin storage 710 for retrieval and processing.

### Key Features of the Social Media Integration 318—

Automatic Coin Creation via social media: A unique system that generates coins based on a user's social media profile, including automatic assignment of the coin's name (based on their handle) and image (based on their profile picture).

Multi-Social Media Verification Mechanism: A verification feature where users can link multiple social media accounts to their coin, with clickable logos for each account, allowing for easy verification of the creator's identity.

OAuth-Based Social Media Integration: The use of OAuth to securely log users into the platform with their social media credentials, simplifying the onboarding process while enabling automatic coin creation.

Future Customization Options: A system that allows users to customize their coin's name and image in future iterations, while initially using their social media profile data for coin creation.

Real-Time Profile Linking and Updating: As users update their social media profiles, the platform could automatically update their coin profile picture and name in real-time (in future iterations).

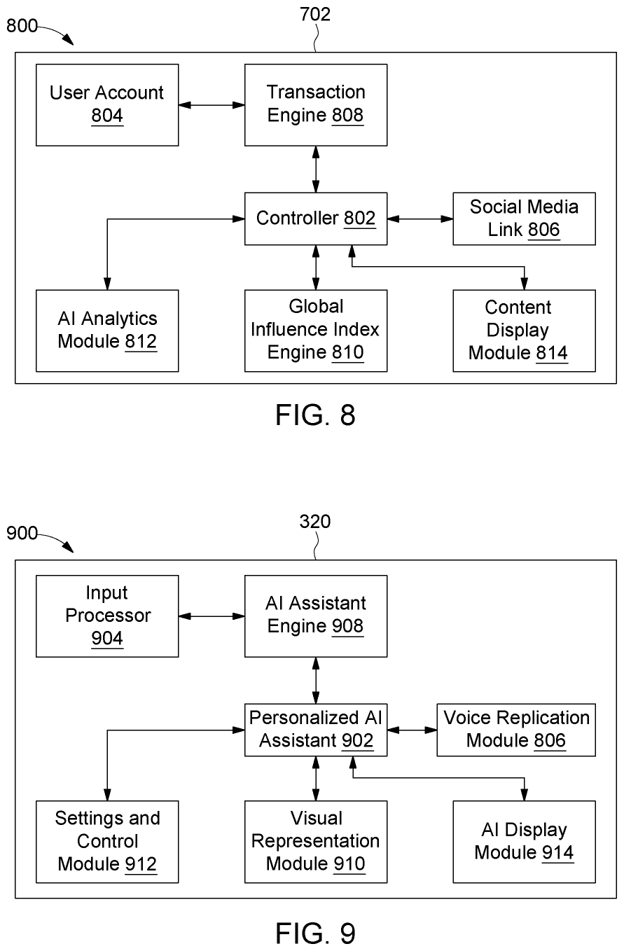

Referring to FIG. 8, illustrates a block diagram 800 of the account association module 702 according to an embodiment of the present disclosure. The account association module 702 explained in the previous FIG. 7 includes a controller 802, a user account 804, a social media link 806, a transaction engine 808, a global influence index engine 810, an artificial intelligence (AI) analytics module 812, and a content display module 814.

The account association module 702 combines real-time social media content with user-generated stock trading, dynamically influencing stock valuations based on social engagement metrics.

Traditional trading platforms lack real-time integration with social media content, missing opportunities to enhance user engagement and reflect personal influence on market valuations. While social media platforms and trading systems exist separately, there is a gap in leveraging a user's social influence directly within trading activities. Existing systems do not provide a mechanism where social media activity can dynamically impact stock valuations in real time, nor do they offer a feedback loop that incentivizes content creation to influence market performance.

The account association module 702 provides a digital trading platform that integrates real-time social media content with user-generated stock coins. When users buy or sell stock coins of other users, short videos or GIFs-sourced from the users' social media accounts-are displayed during the transaction. Users grant permission for their latest Instagram® stories or YouTube® shorts to be showcased, creating an engaging and dynamic experience. The platform introduces a Global Influence Index, where each user's stock valuation is dynamically influenced by their social media interactions, posts, and engagement metrics in real time. This creates a continuous feedback loop between market activity and social media expression, incentivizing users to update content to affect their stock value.

The account association module 702 provides toggle buttons for switching between different content types during transactions, offering a tailored view of social influence interacting with market fluctuations.

The account association module 702 provides a platform for:

Dynamic Media Display: Users can link their social media accounts (e.g., Instagram®, YouTube®) to the platform. When their stock coins are bought or sold, their latest short videos or GIFs are displayed to the buyer or seller during the transaction, given prior permission.

Global Influence Index: A dynamic valuation system where each user's stock value is influenced by their social media activities, including posts, interactions, and engagement metrics. The valuation updates in real time, creating a direct correlation between social influence and market performance.

Feedback Loop Mechanism: Users are incentivized to update their social media content to influence their stock valuations, creating a continuous interaction between social media activity and market reactions.

Content Toggle Feature: The platfom1 includes toggle buttons that allow users to switch between different types of content (e.g., Instagram® Stories, YouTube® Shorts) during transactions, providing a customized viewing experience.

AI-Driven Ecosystem: An AI system integrates social media data with market activity, analyzing and processing vast amounts of data to provide insights and drive the valuation mechanism. This creates a seamless integration of social media and trading platforms, enhancing user engagement and creating a novel market experience where personal influence directly impacts financial valuation.

The controller 802 communicates with the other components of the account association module 702 namely the controller 802, the user account 804, the social media link 806, the transaction engine 808, the global influence index engine 810, the artificial intelligence (AI) analytics module 812, and the content display module 814 and controls the functioning of the components.

The user interface module 206 integrates with the user account 804 that allows users to interact with the platform, view stocks, execute transactions, and manage settings. The user account 804 enables the users to create and manage the user account.

### User Registration and Social Media Linking:

Account Creation: Users create accounts on the platform with standard authentication procedures.

### Permission Granting:

Users are prompted to link their social media accounts (e.g., Instagram®, YouTube®).

Through OAuth protocols, users securely grant the platform permission to access their stories or shorts. Users can select which content types to share and can revoke permissions at any time.

The social media link 806 connects to social media platforms via APIs, retrieves user content, and handles permissions.

The transaction engine 808 processes buy and sell orders, triggers the display of media content during transactions.

The global influence index engine 810 calculates real-time stock valuations based on social media engagement metrics.

The AI analytics module 812 analyzes data from social media and market activities to provide insights and drive the valuation algorithm.

The content display module 814 manages the playback of videos or GIFs during transactions, allowing for toggling between content types.

### Dynamic Media Display During Transactions

### Content Retrieval:

The AI analytics module 812 fetches the user's latest Instagram® Story or YouTube® Short upon a transaction event. Content is cached for efficient retrieval during high-volume transactions.

### Transaction Process:

### Buying Stock Coins:

When a user purchases another user's stock coin, the buyer's interface displays the seller's latest content. The media plays immediately after the transaction is confirmed.

### Selling Stock Coins:

When a user sells a stock coin, the seller's interface displays the latest content of the stock coin's owner.

### User Experience:

Users have the option to mute, skip, or replay the media content. The interface includes controls for toggling between different content types via buttons.

### Global Influence Index

### Valuation Algorithm:

The stock valuation is calculated using an algorithm that factors in social media metrics such as: Number of followers/subscribers, engagement rates (likes, comments, shares, views), frequency of posts and updates. The algorithm updates valuations in real time as new social media data are received.

### AI Integration:

The Al module processes large datasets to detect patterns and anomalies. Machine learning models predict trends and adjust valuations accordingly.

### Feedback Loop Mechanism

### Content Impact on Valuation:

Users observe that updating their social media content can influence their stock valuation. High engagement posts can lead to an increase in stock value.

### Market Impact on Content:

Changes in stock valuation may prompt users to create new content to address market movements. Significant transactions (e.g., large purchases) can trigger notifications encouraging content updates.

### Continuous Interaction:

The ongoing cycle creates a dynamic environment where social activity and market performance are interconnected.

Content Toggle Feature Customization: Users can select preferred content types to display during transactions. Options include Instagram® Stories, YouTube® Shorts, uploaded GIFs or videos.

### Toggle Buttons:

The transaction interface includes buttons to switch between available content types. The system remembers user preferences for future transactions.

### AI-Driven Ecosystem and Data Analytics

### Data Collection:

The platform collects anonymized data on user interactions, transaction volumes, and social media engagement.

Insights Generation: AI algorithms analyze data to provide insights such as: Market trends, social influence patterns, predictive analytics for stock valuation, data security. All data is stored securely with encryption. User privacy is maintained according to data protection regulations.

Example Scenario is significant social event: A renowned tech entrepreneur marries a celebrated artist.

Impact on Stock Valuation: The event generates substantial social media buzz. Engagement metrics for both users spike dramatically.

### Platform Response:

The Global Influence Index reflects the increased social influence, boosting their stock valuations. Investors react by buying more stock coins, further influencing market dynamics.

### Feedback Loop Activation:

The users post new content about the event, sustaining high engagement levels. The ongoing interaction keeps valuations elevated.

### Advantages of the Invention

Enhanced User Engagement: By integrating real-time social media content into trading transactions, the platform creates a more engaging and personalized user experience.

Dynamic Valuation: The Global Influence Index provides a real-time reflection of a user's social influence on their stock valuation, making the market more responsive and interactive.

Feedback Loop Incentivization: Users are motivated to actively manage their social media presence to influence their stock value, promoting continuous platform engagement.

AI Integration: The use of AI and machine learning enhances the accuracy of valuations and provides valuable market insights.

Customization: The content toggle feature allows users to personalize their experience, choosing the type of content they prefer to view during transactions.

### Potential Modifications—

Expansion to Other Social Media Platforms: Integration with additional platforms such as TikTok®, Twitter®, or Facebook® to broaden user engagement.

Advanced Analytics for Users: Providing users with dashboards to monitor how their social media activity impacts their stock valuation and market trends.

Monetization Strategies: Implementing premium features or advertising opportunities within the platform.

Enhanced Security Measures: Incorporating blockchain technology for transaction security and transparency.

Community Features: Adding social networking functionalities within the platform, such as messaging, forums, or collaborative investment groups.

Accordingly, the account association module 702 provides a novel system that seamlessly integrates social media content with a trading platform, creating an engaging environment where users' social influence directly impacts their financial valuation. By introducing real-time content display during transactions and a dynamic valuation mechanism based on social media engagement, the platform fosters continuous user engagement and a unique market experience. The feedback loop between social media activity and stock valuation not only incentivizes users to maintain an active social presence but also generates valuable data insights through AI analytics, enhancing the overall functionality and appeal of the platform.

Referring to FIG. 9 illustrates a block diagram 900 of the artificial intelligence (AI) assistant 320 according to an embodiment of the present disclosure. The AI assistant 320 replicates a user's voice and provides guidance within a platform of the system 200. The AI assistant 320 includes a personalized AI assistant 902, an input processor 904, a voice recognition module 906, an AI assistant engine 908, a visual representation module 910, a settings and control module 912, and an AI display module 914.

The personalized AI assistant 902 replicates a user's voice and provides guidance within a platform. Users upload a short voice sample, which is processed using advanced voice synthesis and deep learning to create a digital voice model identical to the user's own voice. The assistant interacts with the user through this replicated voice, offering responses and guidance that make interactions feel like conversations with oneself. Visually, the assistant is represented as a sentient, ever-shifting flame embodying the organization's logo, providing a dynamic and immersive sensory experience. This unique integration of personalized voice replication and dynamic visual representation transforms user interactions into deeply personal and engaging experiences.

Traditional Al assistants often use generic voices and lack personalization, which can result in a less engaging user experience. Existing systems do not offer voice replication based on a user's own voice, nor do they combine this with dynamic visual representations that respond to user interactions. There is a need for an Al assistant that provides a personalized, immersive experience by utilizing the user's own voice and integrating visually dynamic elements. The personalized AI assistant 902 provides personalized AI assistance by replicating the user's own voice and integrating dynamic visual elements to enhance user engagement and experience.

The AI assistant 902 is dynamically visually represented as a sentient, ever shifting flame that embodies the BlackFlame® logo. This flame-like presence moves with fluidity, creating an immersive and responsive interface. Users have full control using the Enable/Disable Feature to enable or disable the assistant at any time, ensuring privacy and personalization preferences are respected. The AI assistant 902 leverages state-of-the-art AI technologies to provide intelligent responses, enhancing the functionality and usefulness of the assistant. It transforms user interactions within the platform into deeply personal and immersive experiences by combining personalized voice replication with dynamic visual representation.

The input processor 904 communicates with the user interface module 206 to allow the end users 204 to interact with the platform, access the assistant, and manage settings. The user input is processed by the input processor 904.

The voice replication module 906 processes the user's voice sample using voice synthesis and deep learning algorithms to create a digital voice model. Users upload a few minutes voice sample. The system uses advanced voice synthesis and deep learning algorithms to create a digital voice model that replicates the user's own voice.

The AI assistant engine 908 generates intelligent responses to user queries using natural language processing (NLP) and AI algorithms. The AI assistant engine 908 uses the replicated voice from the voice replication module 906 to interact with the user, providing guidance and responding to queries in the user's own voice, making interactions feel like a conversation with oneself.

The visual representation module 910 renders the assistant's visual form as a dynamic, ever shifting flame on the user interface module 206.

The settings and control module 912 provides options for users to enable or disable the assistant and adjust personalization settings.

The AI display module 914 and the user interface module 206 display the visual representation to the end user 204 on the user device. The AI assistant for the user is displayed to the user using the AI display module 914.

The features and steps performed by the AI assistant 320 include:

### User Onboarding and Voice Sample Upload

Account Access: Users log in to their accounts on the platform.

### Voice Sample Upload:

Users are prompted to upload a 1-2 minute voice sample, following guidelines to ensure clarity and quality.

The AI assistant 902 provides instructions on how to record the sample, such as reading a provided script.

### Consent and Permissions:

Users provide explicit consent for their voice to be used for creating the digital voice model. Terms of use and privacy policies are presented for user agreement.

### Voice Replication Process

### Data Processing:

The voice sample is securely uploaded to the server. The voice replication processes the sample using advanced voice synthesis and deep learning algorithms.

### Voice Model Creation:

A digital voice model replicating the user's voice is generated. The model captures the user's tone, pitch, accent, and speech patterns.

### Security Measures:

The voice data is encrypted and stored securely. Access to the voice model is restricted to the user's interactions within the platform.

### AI Assistant Functionality

### Interaction Methods:

Users interact with the assistant via text input, voice commands, or both. The assistant responds using the replicated voice and may provide visual or textual responses as supplementary information.

### Scope of Assistance:

Provides guidance on platform navigation, trading assistance, and answers to user queries. Utilizes NLP to understand and process complex queries.

### Response Generation:

The AI Assistant Engine generates responses based on user input and platform data. Responses are synthesized using the user's voice model for audio playback.

### Dynamic Visual Representation

### Visual Rendering:

The assistant is visually depicted as.an ever-shifting flame, embodying the BlackFlame® logo. The flame moves fluidly, responding to user interactions and voice activity.

### Customization Options:

Users may have options to adjust visual aspects such as color themes or animation speed.

Integration with Voice Interaction:

The flame's movement synchronizes with the assistant's speech, creating a cohesive sensory experience.

### User Control and Settings

### Enable/Disable Feature:

Users can easily enable or disable the assistant at any time via the settings menu. A toggle switch or button is provided for quick access.

### Privacy Settings:

Users can manage permissions related to voice data usage. Options to delete the voice model and associated data are available.

### Assistant Behavior Settings:

Users can adjust the assistant's level of proactivity, response style, and interaction preferences. Security and Privacy Measures

### Data Protection:

Voice samples and models are encrypted both in transit and at rest. Compliance with data protection regulations (e.g., General Data Protection Regulation (GDPR), Central Consumer Protection Authority (CCPA)) is ensured.

### Authentication and Access Control:

Secure authentication methods prevent unauthorized access to the assistant and voice data.

### Consent Management:

Users provide explicit consent for voice replication and can revoke consent at any time.

### Misuse Prevention:

Measures are in place to verify that the voice sample belongs to the account owner. Biometric data handling policies prevent misuse or unauthorized replication.

### Example Interaction Scenario

### User Query:

The user asks, “What's the status of my portfolio today?”

### Assistant Response:

The assistant analyzes the user's portfolio data. Responds in the user's own voice: “Your portfolio has increased by 2% today, with significant gains in TechCorp® and GreenEnergy® stocks.'”

### Visual Interaction:

As the assistant speaks, the flame visual animates smoothly, enhancing the interaction.

### User Follow-Up:

The user can ask additional questions or request more details, continuing the conversation seamlessly.

### Advantages of the AI Assistant 902—

Personalized User Experience: By replicating the user's own voice, the assistant provides a unique and deeply personal interaction that enhances user engagement.

Immersive Sensory Interaction: The dynamic visual representation of the assistant as an ever-shifting flame adds a captivating visual element that complements the personalized audio.

Enhanced Functionality: Utilizing advanced AI and Natural Language Processing (NLP) technologies allows the assistant to handle complex queries and provide meaningful guidance within the platform.

User Control and Privacy: Users have full control over enabling or disabling the assistant and managing their voice data, ensuring comfort and trust in the system.

Security Measures: Robust security protocols protect user data, addressing potential concerns related to voice replication technologies.

### Potential Modifications:

Alternative Visual Representations: Users could choose from different visual themes or avatars to represent the assistant, catering to personal preferences.

Expanded Interaction Modes: Integration with oilier input methods, such as gesture recognition or augmented reality, to further enhance interaction.

Multi-Language Support: The system could support multiple languages, allowing the assistant to interact with users in their preferred language.

Integration with Other Platforms: The assistant could be extended to interact with other applications or platforms, providing a consistent personalized experience across services.

Adaptive Learning: Incorporating machine learning algorithms that allow the assistant to adapt to the user's behavior and preferences over time.

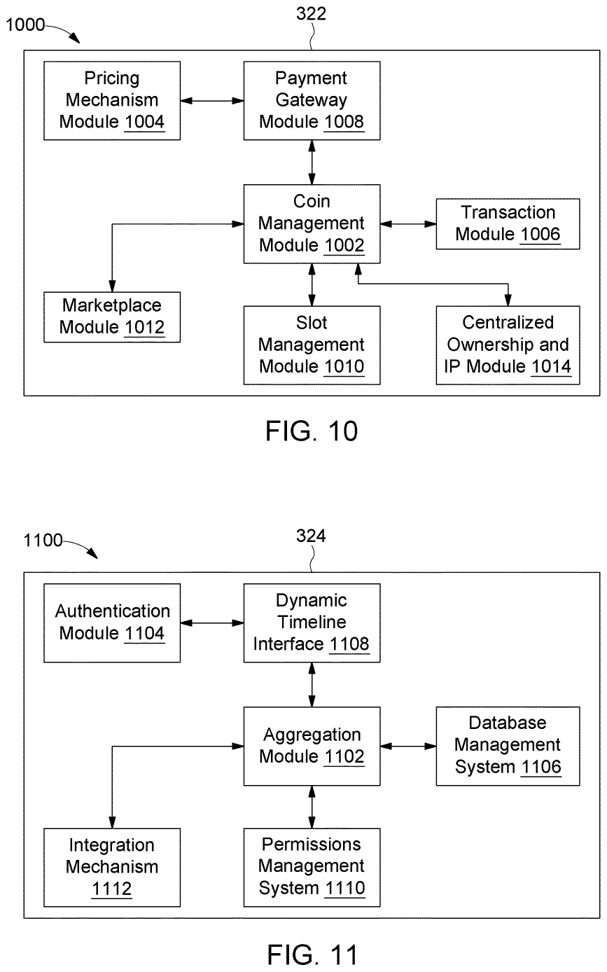

Referring to FIG. 10, illustrates a block diagram 1000 of the payment gateway 322 according to an embodiment of the present disclosure. The payment module 322 provides a payment gateway for the user coins. The payment module 322 includes a coin management module 1002, a pricing mechanism module 1004, a transaction module 1006, a payment gateway module 1008, a slot management module 1010, a marketplace module 1012, and a centralized ownership and intellectual property (IP) module 1014.

A dynamic digital currency platform enables users, particularly influencers and individual businesses, to create and manage their own coins, which function as digital currencies within the ecosystem. The platform incorporates a proprietary pricing mechanism based on supply and demand dynamics, utilizing minting and burning processes to adjust coin value in real-time. Users can purchase products or services directly from coin creators using these coins, creating a direct correlation between market activity and the cost of offerings. The system includes slot mechanics for strategic investment, an integrated payment gateway for seamless transactions across multiple platforms, and centralized ownership of all coins and associated content by the platform. While initially tailored for influencers, the system is adaptable for use by any individual business, from solo entrepreneurs to multi-person corporations.

In the evolving digital economy, influencers and individual businesses seek innovative ways to monetize their brand, engage with their audience, and offer unique value propositions. Traditional methods often lack dynamic interaction and real-time valuation reflective of market demand.

Existing platforms do not offer a comprehensive system where influencers or businesses can issue their own digital currencies tied to their offerings, nor do they provide mechanisms for direct integration with various external platforms. There is a need for a unified system that allows for dynamic coin valuation, strategic investment, and seamless transactions while maintaining centralized control over intellectual property. This invention addresses these needs, initially focusing on influencers but designed to be scalable and applicable to any individual business, regardless of size.

The payment module 322 provides a comprehensive digital currency platform where:

Influencer and Business Coin Creation: Influencers and individual businesses can create and manage their own coins, serving as digital currencies within the platform.

Proprietary Pricing Mechanism: The value of each coin fluctuates based on a proprietary algorithm that considers real-time supply and demand, utilizing minting and burning processes.

Direct Purchase of Offerings: Users purchase products or services directly from coin creators: using the creator's coin, linking coin demand to the desirability of the offerings.

Slot Mechanics: Users have a limited number of slots to hold different coins, adding a strategic element to investment decisions.

Integrated Payment Gateway: A dedicated payment gateway and wallet system (Payment Gateway and Wallet) allows for seamless transactions across various platforms, including automatic fiat-to-coin conversion.

Centralized Ownership: The platform retains ownership of all coins and associated content, managing intellectual property rights and integration with external platforms.

While the system is initially implemented for influencers, it is designed to accommodate any type of individual business, from solo entrepreneurs to multi-person corporations, enabling them to leverage the platform's features for their specific needs.

The coin management module 1002 allows influencers and businesses to create and manage their own coins.

The pricing mechanism module 1004 implements the proprietary algorithm for dynamic coin valuation.

The transaction module 1006 facilitates buying, selling, and transferring of coins.

The payment gateway module 1008 integrates the organization's (BlackFlame®) Payment Gateway and Wallet with external platforms.

The slot management module 1010 manages the allocation of coins within user wallets.

The marketplace module 1012 provides a decentralized marketplace for products and services.

The centralized ownership and IP module 1014 manages ownership rights and intellectual property.

### Influencer and Business Coin Creation:

Registration and Authentication: Influencers and businesses register on the platform and are authenticated.

### Coin Creation Process:

Through the Coin Management Module, they create their own coin, assigning a name, symbol, and initial parameters. The platform owns all rights to the coins and associated content, as managed by the

### Centralized Ownership and IP Module

### Adaptability:

While designed for influencers initially, the coin creation process is flexible to accommodate businesses of all scales, allowing solo entrepreneurs and corporations to leverage the platform.

### Proprietary Pricing Mechanism

### Dynamic Valuation Algorithm:

The Pricing Mechanism Module utilizes a logarithmic algorithm considering demand and supply factors.

### Minting and Burning Processes:

Minting: Occurs when users purchase coins, increasing supply but potentially raising value due to demand.

Burning: Occurs when users sell coins back to the platform, decreasing supply and adjusting value accordingly.

### Real-Time Adjustments:

Coin value reflects real-time market activity, influenced by the coin creator's engagement and offerings.

### Direct Purchase of Offerings

### Products and Services Priced in Creator's Coin:

Influencers and businesses price their offerings in their own coin.

Users acquire the coin to make purchases, directly thinking coin demand to the attractiveness of the offerings.

### Applicability to Businesses:

Businesses can sell goods or services (e.g., consulting sessions, products, subscriptions.) using their coin, making the system versatile across different industries.

### Slot Mechanics

### Strategic Investment Structure:

Users have limited slots in their wallets, each dedicated to a different coin.

Encourages users to select coins based on the potential value of associated offerings from influencers or businesses.

### Unlimited Accumulation Within Slots:

Users can hold unlimited amounts of a specific coin within its assigned slot.

### Adaptable Slot System:

The slot mechanics can be scaled to accommodate a growing number of businesses using the platform.

### Integrated Payment Gateway and Wallet

### BlackFlame® Payment Gateway and Wallet:

Facilitates transactions across multiple platforms.

Includes APIs and SDKs for integration with platforms relevant to both influencers and businesses.

### Automatic Fiat-to-Coin Conversion:

Simplifies the purchasing process for users by allowing automatic conversion at the point of sale.

### User Interface Adaptations:

Dashboards and tools designed to meet the needs of both influencers and businesses, offering features like inventory management and service scheduling.

### Marketplace and Decentralized Offerings

### Platform Marketplace:

A centralized marketplace where influencers and businesses can List their offe1ings.

### Future Decentralization:

Plans to enable users and businesses to create their own marketplaces or integrate with existing e-commerce platforms.

### Enhanced Search and Discovery:

Advanced filtering and categorization to help users find offerings from both influencers and businesses.

### Centralized Ownership and! Intellectual Property Management

### Rights Management:

The platform owns all coins and content, ensuring consistent IP management.

Integration with External Platforms:

Manages licensing and compliance for content used across various platforms.

### Applicability to Businesses:

Businesses can leverage the platform's IP management to protect their brand and offerings.

### Operational Flow

### Creator Engagement:

Influencers or businesses create a coin and List offerings priced in their coin.

They promote their coins and offerings through various channels.

### User Interaction:

Users explore offerings and decide to purchase.

They acquire the creator's coin through the platform or via automatic conversion during checkout.

### Transaction Execution:

The payment gateway processes the transaction, updating coin supply through minting or burning.

Users receive the product or service, and their wa1let reflects the coin balance.

### Value Fluctuation:

Coin value adjusts based on demand, influenced by the creator's market strategies and user engagement.

### Advantages of the Payment Gateway 322—

Versatility Across User Types: Designed initially for influencers but adaptable for any individual business, making it a versatile platform for various industries.

Dynamic Market Engagement: Enables creators to directly influence their coin's value through offerings and engagement strategies.

Strategic Investment Mechanics: Slot limitations and fluctuating coin values encourage users to make thoughtful investment decisions across a diverse range of creators.

Seamless Multi-Platform Integration: The integrated payment gateway allows for easy adoption and use across platforms relevant to both influencers and businesses.

Centralized IP Management: Simplifies intellectual property management for creators, ensuring compliance and protection across different platforms.

### Potential Modifications and Embodiments

### Business-Specific Features:

Implementing tools tailored for business operations, such as inventory management, appointment scheduling, or customer relationship management within the platform.

### Industry-Specific Adaptations:

Customizing the platform to suit specific industries, such as consulting, retail, or digital services, by integrating relevant functionalities.

### Enhanced Analytics:

Providing advanced analytics to businesses and influencers for better understanding of market trends, customer behavior, and coin performance.

The payment gateway 322 offers a comprehensive Investment and currency platform that empowers influencers and individual businesses by enabling them to create their own Stock coins tied to their offerings. It enhances user engagement through dynamic coin valuation and strategic investment mechanics, facilitated by an integrated payment gateway that ensures seamless transactions across multiple platforms. By centralizing ownership and intellectual property management, the platform provides a secure and compliant environment adaptable for a wide range of users-from solo entrepreneurs to multi-person corporations-reflecting true market sentiments and fostering a vibrant digital economy.

### Industrial Applicability

This invention is applicable in the digital economy sector, serving social media influencers, individual entrepreneurs, and businesses of all scales. It provides a novel approach to monetization, user engagement, and digital currency management, with potential applications across various industries, including retail, consulting, entertainment, and more.

Referring to FIG. 11, illustrates a block diagram 1100 of the investment platform 324 according to an embodiment of the present disclosure. The investment platform 324 performs aggregating social media content into a centralized, dynamic timeline within a user investment platform, enhancing user engagement by integrating social activities with trading interactions.

The investment platform 324 provides a system and method for integrating a dynamic, aggregated social media timeline into a user investment platform. Users can connect to multiple social media accounts, and the investment platform 324 retrieves and displays their comments in a centralized, scrollable timeline focused on a particular user when searched. This timeline includes posts, stories, videos, and other updates from platforms like Instagram®, YouTube®, and Twitter®. Integration allows investors to view the1atest social activities of users they follow or have invested in, enhancing engagement and linking social presence with trading activity. The system includes authentication, data aggregation, permissions management, and real-time updates, all within a secure and compliant framework.

Users currently have to navigate multiple social media platforms to view updates, which is time-consuming and fragmented. Investment platforms lack real-time social integration that could influence trading decisions. There is a need for a unified system that consolidates social media content and links it to user investment activities. Social media aggregators exist but are not integrated with investment or trading platforms. Investment platforms may offer limited social features but do not provide cross platform content aggregation. A system that seamlessly integrates a user's social media activities into an investment platform, providing a dynamic and comprehensive view that can influence and enhance trading interactions is desired. The investment platform 324 provides a platform where users can connect their various social media accounts (e.g., Instagram®, YouTube®, Twitter®).

The investment platform 324 features a dynamic timeline that aggregates and displays updates from all connected accounts into a centralized, scrollable feed focused on a particular user. The timeline includes posts, stories, videos, tweets, and other social updates in real time. Investors and followers can view the aggregated social content of users they are interested in or have invested in. The integration enhances the social experience and creates opportunities for users to influence engagement and trading activity through their social media presence.

### Advantages:

Enhanced Engagement: Users can see a comprehensive view of social activities, promoting increased interaction.

Influence on Trading: Real-time social updates can impact investor perceptions and trading decisions.

Convenience: Consolidates multiple platforms into one interface, saving time and effort for users.

Strategic Integration: Links social media activity with investment opportunities, creating a unique user experience.

The investment platform 324 includes an aggregation module 1102, an authentication module 1104, a database management system 1106, a dynamic timeline interface 1108, a permissions management system 1110, and an integration mechanism 1112.

The aggregation module 1102 comprises a backend server, database management system (e.g., Supabase®), and a front-end interface (e.g., built with React®). Integrates with external social media APIs to fetch user data. Manages authentication, data storage, content display, and user interactions.

The authentication module 1104 allows the users to log in and connect multiple social media accounts via authentication protocols such as OAuth2 protocols.

The investment platform 324 would also include a dynamic timeline, focused on one particular user when searched, that acts as a centralized timeline, displaying updates from all of a user's connected social media accounts. This unified feed would pull in Instagram® posts, stories, YouTube® shorts, tweets, and any other linked social updates, presenting them in a continuous, scrollable timeline. Users would see the latest activities of those they follow or have invested in, much like scrolling through a Facebook® wall-but with a comprehensive view that spans across multiple platforms.

This integration allows for a richer social experience, where investors can see the latest posts, market reactions, and updates in real time. It also creates opportunities for the user whose stock coin is being traded to influence engagement through their posts, as their latest social activities are always visible to those interacting with their stock. This feature ties the market with real-time social interactions, creating a seamless connection between trading activity and social presence.

### User Authentication and Social Media Integration

User Registration: Users register on the platform and create profiles.

Authentication is managed through services like Supabase®.

The aggregation module 1102 retrieves social media content from connected accounts using platform-specific APIs. Social Media Account Linking: Users can connect their social media accounts using OAuth2 authentication protocols. Platforms include, but are not limited to, Instagram®, YouTube®, Twitter®.

The database management system 1106 stores and organizes the aggregated content in chronological order.

### Permission Management:

Users grant permissions for the platform to access specific types of data (e.g., posts, stories). Users can select which content is shared on the platform.

### Data Aggregation and Storage

### API Integration:

The system uses APIs provided by each social media platform to fetch user content. Data includes posts, stories, videos, tweets, etc.

### Database Management:

Fetched data is stored in a structured database using Supabase®'s features. Data is organized chronologically and associated with the respective user.

### Caching and Rate Limits:

Implements caching strategies to minimize API calls and handle rate limits. Employs background jobs or webhooks for periodic data updates.

The dynamic timeline interface 1108 displays the aggregated social media content focused on a particular user when searched, presented in a continuous, scrollable format.

### Dynamic Timeline Display

### User Interface:

The dynamic timeline is presented as a continuous, scrollable feed. Displays aggregated content in chronological order.

### Focused View:

When a particular user is searched or selected, the timeline focuses on that user's aggregated social media content.

### Real-Time Updates:

The timeline updates dynamically as new content is fetched. Users can see the latest activities without manual refresh.

The permissions management system 1110 enables users to control which content is shared and displayed, ensuring compliance with privacy settings and platform policies.

### Privacy and Permissions Management

### User Control:

Users have full control over what content is shared on the platform. Can select specific posts or types of content to include or exclude.

### Permissions Handling:

The system respects privacy settings from the social media platforms. Ensures that private or restricted content is not displayed.

### Compliance:

Adheres to the terms of service and data usage policies of each social media platform. Implements measures to comply with data protection regulations like GDPR and CCPA.

### Technical Implementation

### Backend Services:

Supabase® is used for authentication, database management, and permission controls.

### Frontend Framework:

React or similar frameworks are used to build the user interface. Ensures a responsive and interactive user experience.

### Data Updates:

Background jobs, cron tasks, or webhooks are set up for periodic data fetching. Efficient data handling to maintain performance and scalability.

### Security Measures

### Data Protection:

Encryption of sensitive data, including authentication tokens and personal information.

### Secure Authentication:

Utilizes secure OAuth2 protocols for connecting social media accounts.

### Access Control:

Implements role-based access controls and permission settings.

The integration mechanism 1112 links the dynamic timeline to the user's investment platform profile, allowing investors to view social media updates of users they follow or have invested in.

### Integration with Investment Platform

### Influence on Trading Activity:

Investors can view social media updates of users they have invested in. Real-time social interactions may impact trading decisions.

### User Engagement:

Users can leverage their social media presence to influence their stock coin's performance. Encourages users to remain active on social media.

### Implementation Variations:

Alternative authentication services or databases can be used. The system can support additional social media platforms as APIs become available.

### User Interaction Examples:

Scenario where an investor views a user's timeline before deciding to invest. Example of a user controlling which posts are displayed on the platform.

Performance Optimization:

Use of asynchronous data fetching to improve responsiveness. Load balancing strategies for handling high volumes of data and users.

### Potential Modifications and Alternative Embodiments

### Interactive Features:

Allowing users to interact with the aggregated content (e.g., liking or commenting) directly from the platform.

### Analytics Integration:

Providing sentiment analysis or engagement metrics based on the aggregated social media content.

### Monetization Strategies:

Offering premium features for enhanced timeline customization or additional analytics.

### Compliance Enhancements:

Implementing additional measures for regions with strict data protection laws. This provides a novel system that bridges the gap between social media and investment platforms. By aggregating a user's social media content into a dynamic timeline within the investment platform, it offers a comprehensive and engaging experience for both users and investors. The integration facilitates real-time interactions and influences trading activities, setting the platform apart in the market.

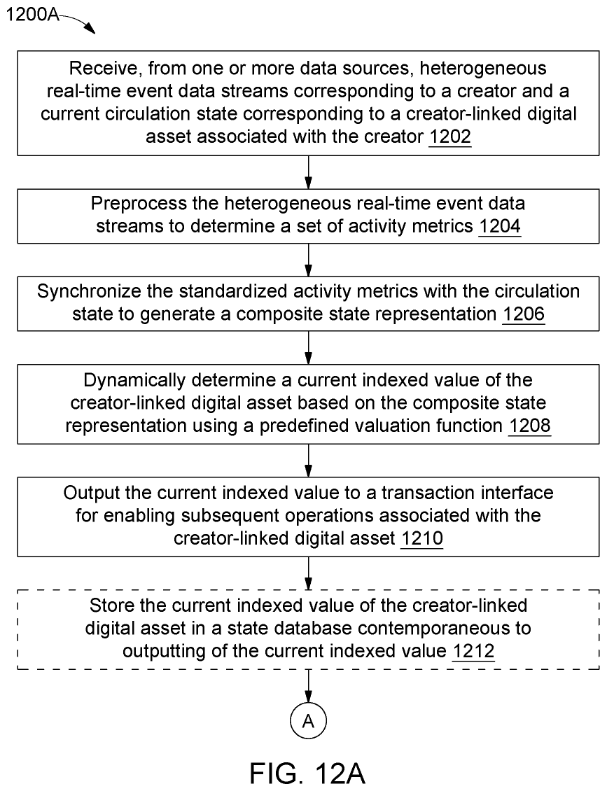

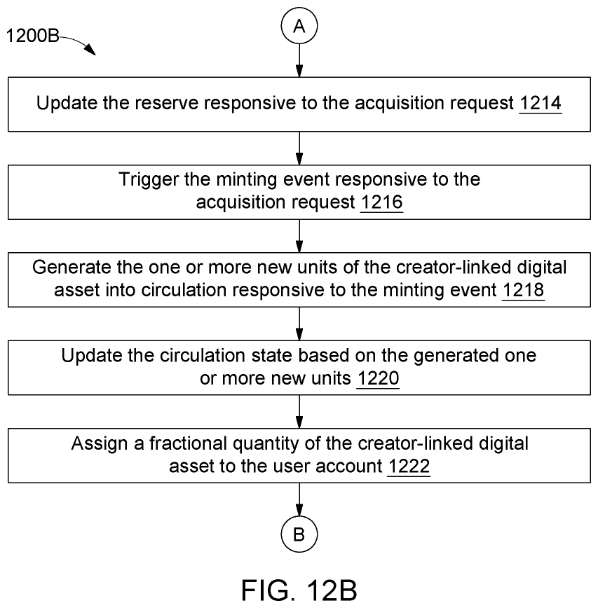

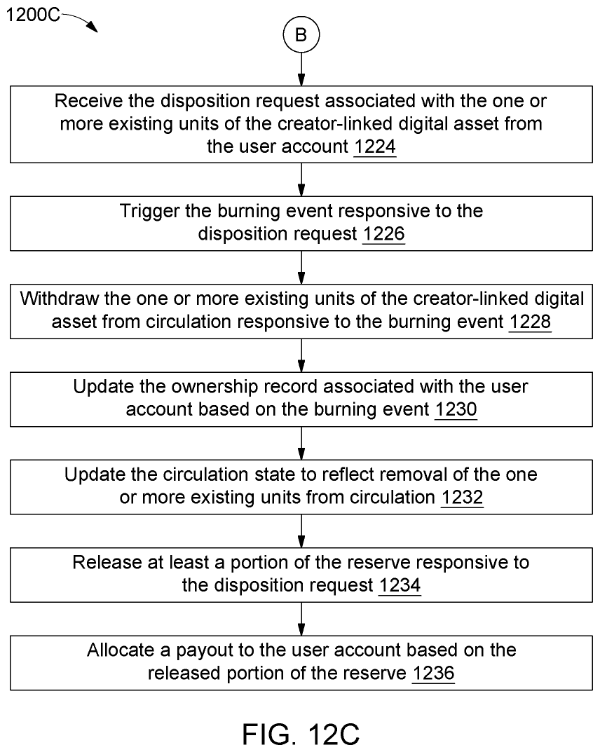

Referring to FIG. 12A, an exemplary process 1200A for dynamically maintaining a creator-linked digital asset platform is depicted via a flowchart, according to an embodiment of the present disclosure. In an embodiment, the process 1200A may be implemented via the server 102 of the system 100.

The process 1200A may include receiving, from one or more data sources, heterogeneous real-time event data streams corresponding to a creator and a current circulation state corresponding to a creator-linked digital asset associated with the creator, at step 1202. The real-time event data may include a set of asynchronous data elements.

Further, the process 1200A may include preprocessing the heterogeneous real-time event data streams to determine a set of activity metrics, at step 1204.

Further, the process 1200A may include synchronizing the standardized activity metrics with the circulation state to generate a composite state representation, at step 1206.

Further, the process 1200A may include dynamically determining a current indexed value of the creator-linked digital asset based on the composite state representation using a predefined valuation function, at step 1208.

Further, the process 1200A may include outputting, by the server, the current indexed value to a transaction interface for enabling subsequent operations associated with the creator-linked digital asset, at step 1210.

Further, the process 1200A may include storing the current indexed value of the creator-linked digital asset in a state database contemporaneous to outputting of the current indexed value, at step 1212.

Referring to FIG. 12B, an exemplary process 1200B for performing acquisition-event-driven reserve updating, minting, circulation-state updating, and fractional allocation associated with a creator-linked digital asset is depicted via a flow chart, according to an embodiment of the present disclosure. In an embodiment, the process 1200B may be implemented via the server 102 of the system 100.

The process 1200B may include updating the reserve responsive to the acquisition request, at step 1214.

Further, the process 1200B may include triggering the minting event responsive to the acquisition request, at step 1216.

Further, the process 1200B may include generating one or more new units of the creator-linked digital asset into circulation responsive to the minting event, at step 1218.

Further, the process 1200B may include updating the circulation state based on the generated one or more new units, at step 1220.

Further, the process 1200B may include assigning a fractional quantity of the creator-linked digital asset to the user account, at step 1222. The fractional quantity may be reflected within an ownership record associated with the user account.

Referring to FIG. 12C, an exemplary process 1200C for performing disposition-event-driven burning, circulation-state reduction, reserve release, and payout allocation associated with a creator-linked digital asset is depicted via a flow chart, according to an embodiment of the present disclosure. In an embodiment, the process 1200C may be implemented via the server 102 of the system 100.

The process 1200C may include receiving the disposition request associated with one or more existing units of the creator-linked digital asset from the user account, at step 1224.

Further, the process 1200C may include triggering the burning event responsive to the disposition request, at step 1226.

Further, the process 1200C may include withdrawing the one or more existing units of the creator-linked digital asset from circulation responsive to the burning event, at step 1228.

Further, the process 1200C may include updating the ownership record associated with the user account based on the burning event, at step 1230.

Further, the process 1200C may include updating the circulation state to reflect removal of the one or more existing units from circulation, at step 1232.

Further, the process 1200C may include releasing at least a portion of the reserve responsive to the disposition request, at step 1234.

Further, the process 1200C may include allocating a payout to the user account based on the released portion of the reserve, at step 1236.

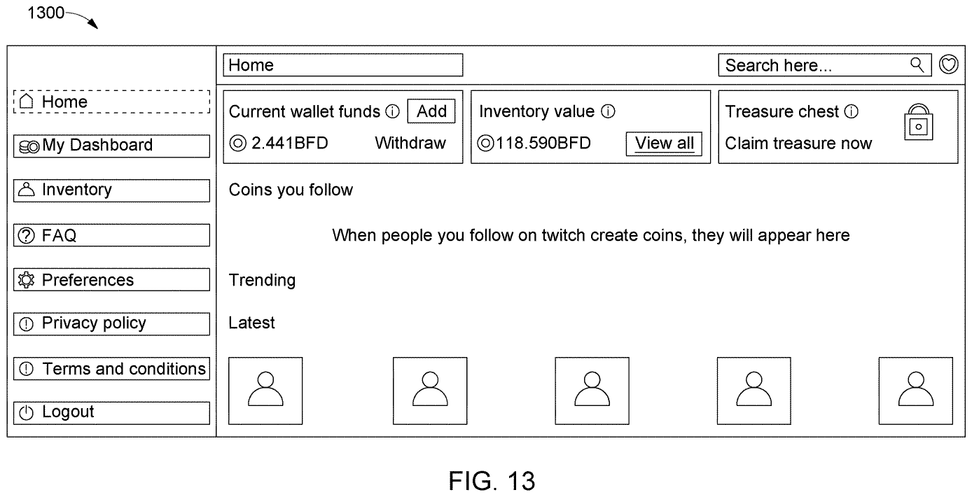

FIGS. 13-23 illustrate graphical user interfaces (GUIs) of the platform of the system 100 in accordance with an embodiment of the present disclosure. The GUIs are displayed to the end user 104 on the respective end user devices 102 using the user interface module 106.

Referring to FIG. 13, a Graphical User Interface (GUI) 1300 provides a user-friendly display on the end user device(s) 102, showing a home page of the application in accordance with an embodiment of the present disclosure. The home page features key information, such as the current wallet funds, inventory value and treasure chest associated with the user account. The current wallet funds show the amount of money or virtual currency the user 104 has available in their account or wallet at a given moment. The inventory value is the total worth of all the items you currently possess in your inventory, and the treasure chest contains the rewards of the users. Additionally, the GUI 1300 includes a search functionality for easy navigation. Other available options on the home page include links to the “My Dashboard,” “About Inventory,” “FAQ,” as well as sections for “Preferences,” “Privacy Policy,” “Terms and Conditions,” and a “Logout” option.

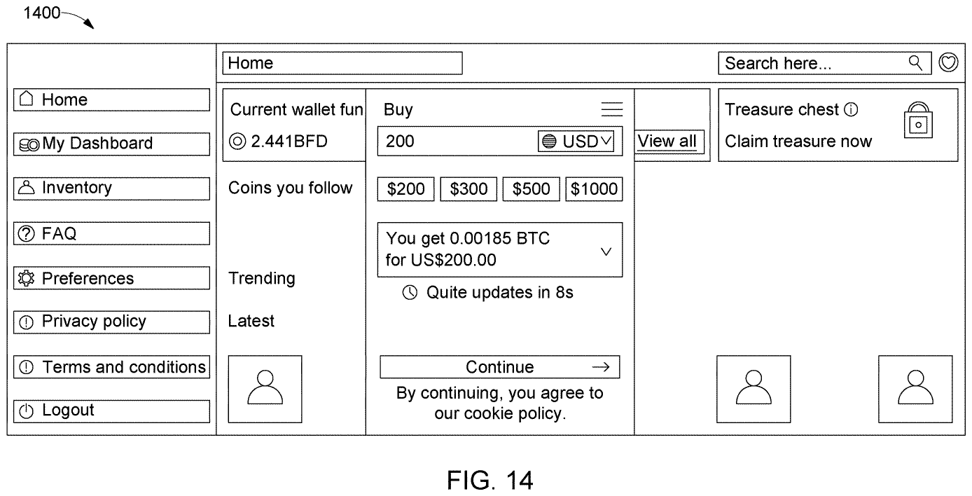

Referring to FIG. 14, a GUI 1400 provides a user-friendly display on the end user device(s) 102, designed for purchasing Bitcoin (BTC) through a provider in accordance with an embodiment of the present disclosure. The user interface displays the equivalent value of BTC converted into the platform's native digital currency, BlackFlame Dollar (BFD). The platform of the system 100 performs internal calculations to ensure that the value of the purchased BTC is accurately reflected in the issuance of BFD. All bitcoins purchased is securely stored in a dedicated treasury wallet. The user interface also includes a continue functionality.

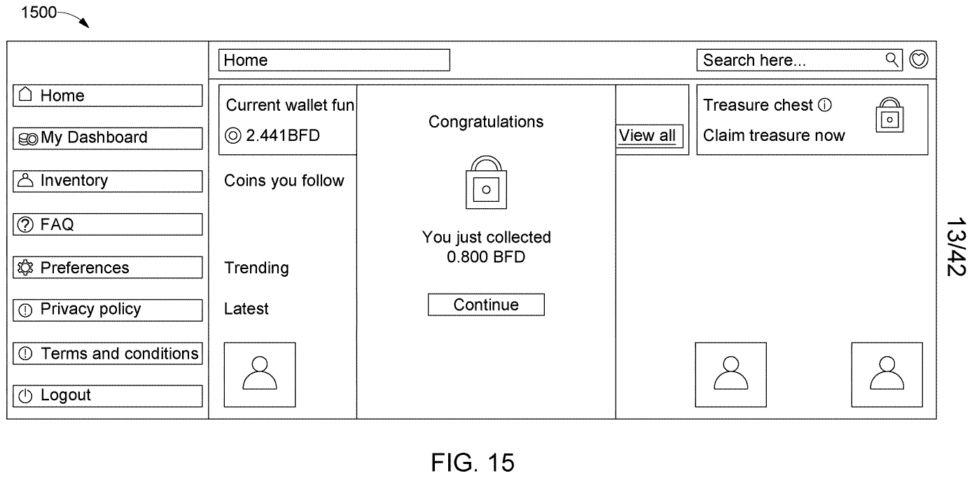

Referring to FIG. 15, a GUI 1500 presents a user-friendly display on the end user device(s) 102, showing the rewards interface for active users 104 in accordance with an embodiment of the present disclosure. This interface highlights the user's accumulated rewards. Each time a user buys or sells a coin, a small percentage of the transaction value is contributed to a community chest. Each coin has its own separate community chest, which is shared among holders of that specific coin. Users can claim their rewards from the community chest periodically by logging into the platform. Additionally, users have the option to either manually collect their rewards or set up automatic claims.

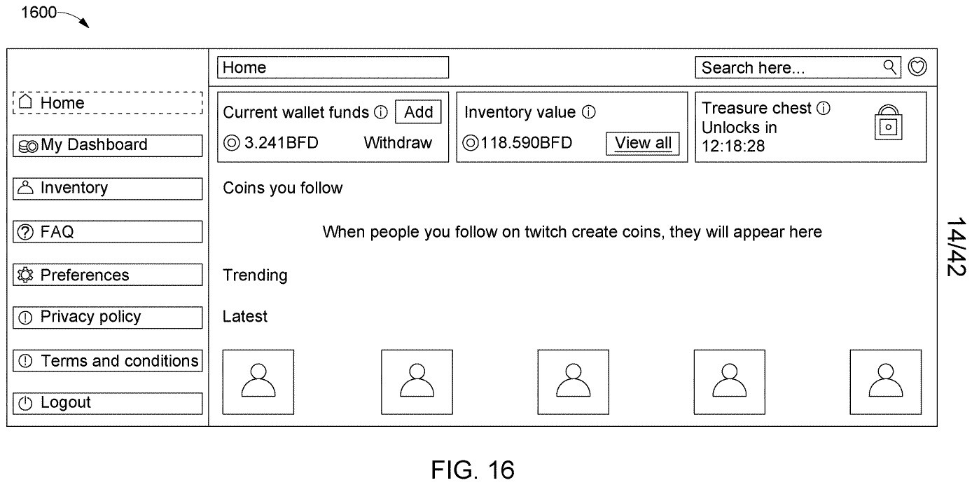

Referring to FIG. 16, a GUI 1600 provides a user-friendly display on the end user device(s) 102, showing the home page of the application in accordance with an embodiment of the present disclosure. The home page features key information, such as the current wallet funds, inventory value and treasure chest. The current wallet funds show the amount of money or virtual currency you have available in your account or wallet at a given moment. The inventory value is the total worth of all the items you currently possess in your inventory, and treasure chest holds the accumulated rewards for users. It displays the next unlock time for the rewards, which are set as periodic time. From this section, users can track when their rewards will become available and claim them once the specified time is reached. Additionally, the GUI 1600 includes a search functionality for easy navigation. Other available options on the home page include links to the “My Dashboard,” “About Inventory,” “FAQ,” as well as sections for “Preferences,” “Privacy Policy,” “Terms and Conditions,” and a “Logout” option.

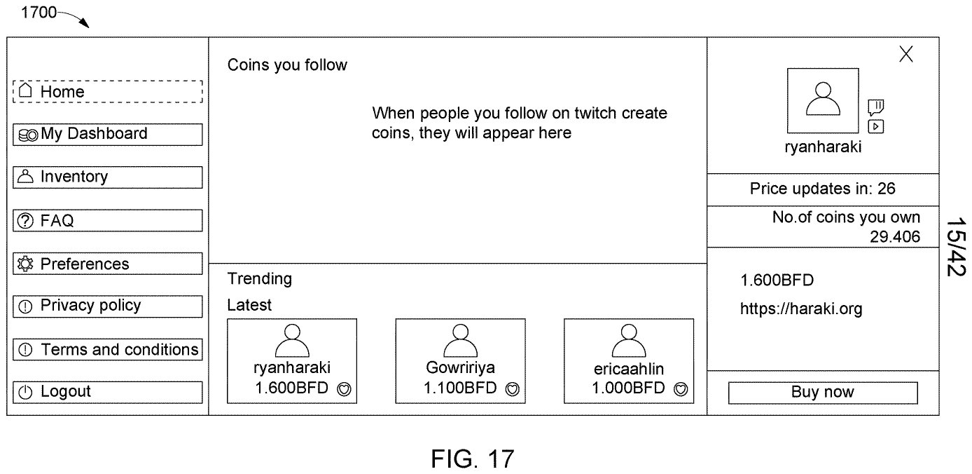

Referring to FIG. 17, a GUI 1700 provides a user-friendly display on the end user device(s) 104, showing the home page of a user profile within the application of the platform in accordance with an embodiment of the present disclosure. The user profile includes details of multiple providers and displays the current wallet balance. The current wallet funds represent an amount of money or virtual currency a user has available in the account or wallet at a given moment. Additionally, the user profile highlights price updates and the number of coins owned by each provider.

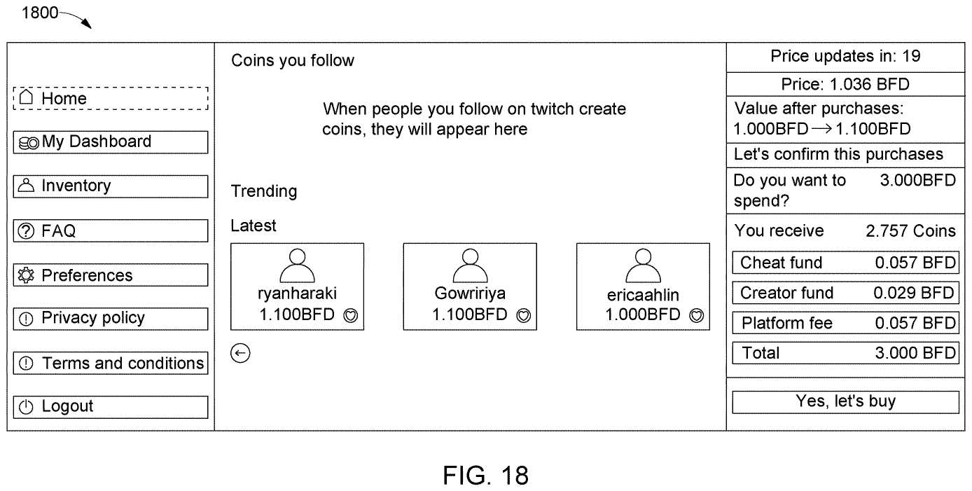

Referring to FIG. 18, a GUI 1800 provides a user-friendly display on the end user device(s) 104, showing the home page for buying or selling coins within the application in accordance with an embodiment of the present disclosure. The GUI 1800 displays the current coin price along with the updated price after a transaction. It also presents additional details, including chest fund, creator fund, platform fee, and total BFD. Finally, the GUI 1800 offers an option to proceed with buying or selling coins to confirm the purchase or sale.

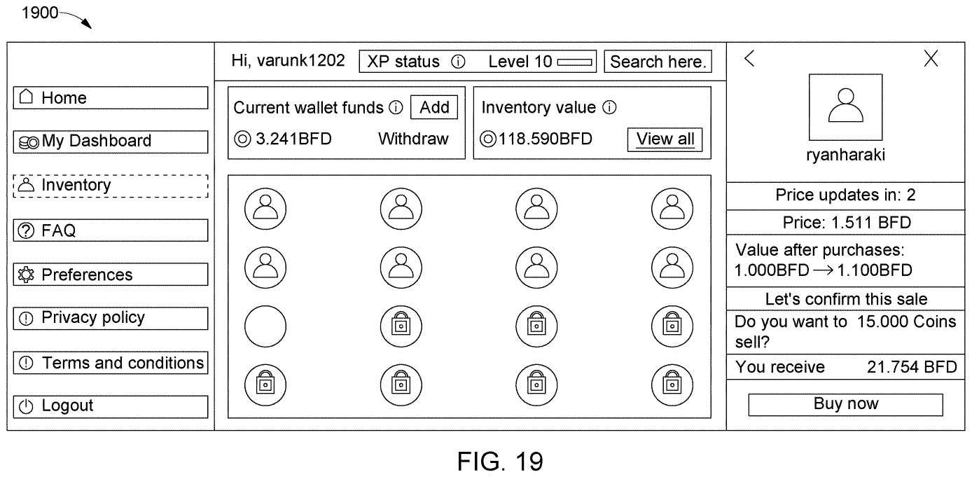

Referring to FIG. 19, a GUI 1900 provides a user-friendly display on the end user device(s) 104, showing the home page of the user profile for selling coins within the application in accordance with an embodiment of the present disclosure. The GUI 1900 displays the user profile that shows the option of selling coins. It also presents the current price along with the price updates and shows the purchase value in the platform's native digital currency after the transaction. Additionally, the GUI 1900 includes a “Yes, let's sell” functionality to proceed with selling coins.

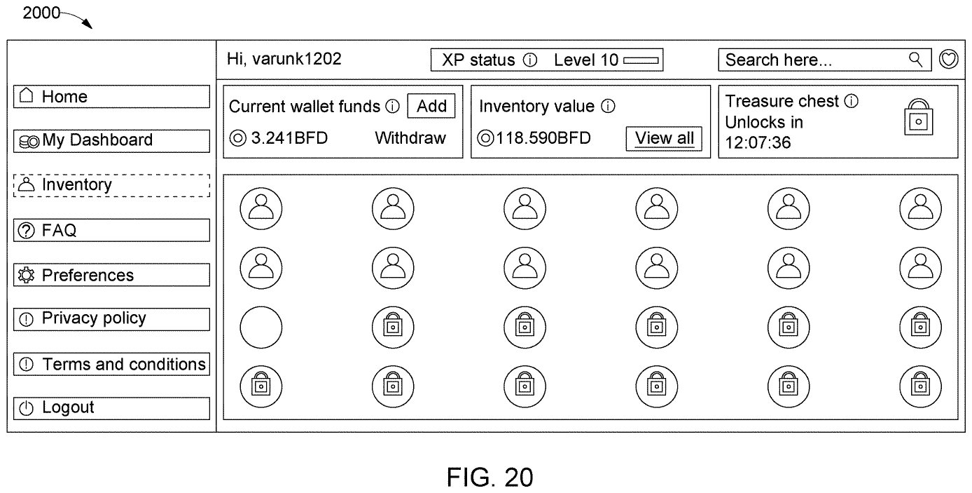

Referring to FIG. 20, a GUI 2000 provides a user-friendly display on the end user device(s) 104, showing the inventory of the user 104 within the application of the system 100 in accordance with an embodiment of the present disclosure. The GUI 2000 displays all providers depicted in FIG. 20 and includes the user's level, alongside key information such as current wallet funds, inventory value, and the treasure chest. The treasure chest indicates the next unlock time for user rewards, which are periodically available for active users. Additionally, the GUI 2000 features a search functionality for easy navigation and displays to see the user's XP status, among other features.

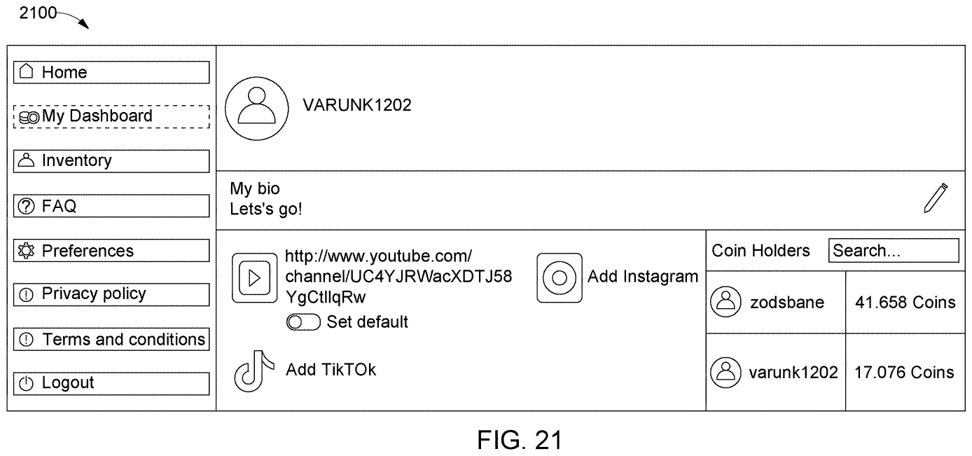

Referring to FIG. 21, a GUI 2100 provides a user-friendly display on the end user device(s) 104, showing the “My Dashboard” section within the application in accordance with an embodiment of the present disclosure. The “My Dashboard” includes user information such as the user's biodata, social media handles, coin holdings, and various other details. Furthermore, the application allows users to edit their information directly through the dashboard. Users update their social media profiles, and the application could automatically update their coin profile picture and name in real-time.

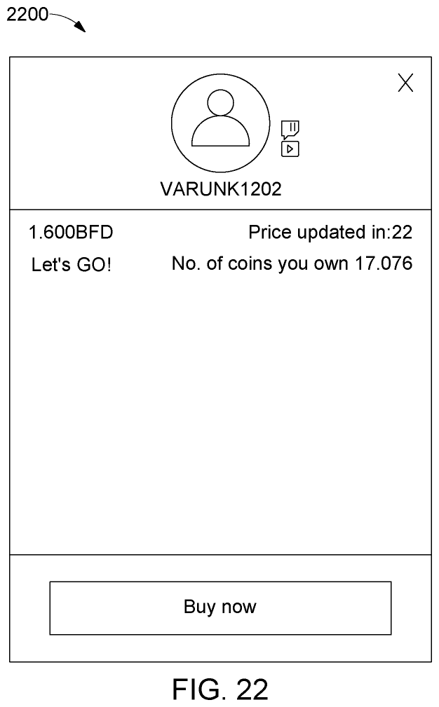

Referring to FIG. 22, a GUI 2200 provides a user-friendly display on the end user device(s) 104, showing transactions of the user within the application in accordance with an embodiment of the present disclosure. The GUI 2200 includes price updates with the number of coins user own. When the user's coins are bought or sold, their latest short videos or GIFs are displayed to the buyer or seller during the transaction.

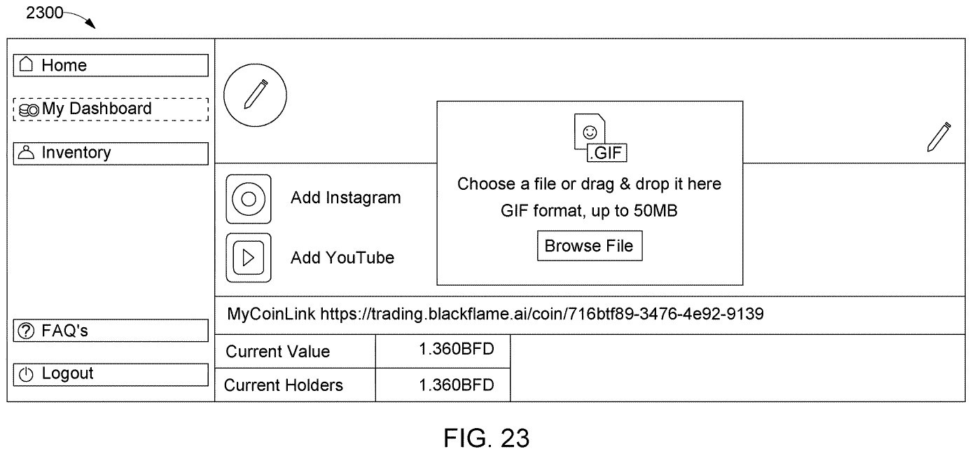

Referring to FIG. 23, a GUI 2300 provides a user-friendly display on the end user device(s) 104, showing an upload able version of the “My Dashboard” within the application in accordance with an embodiment of the present disclosure. The GUI 2300 features the user's dashboard with a file upload option, enabling users to upload their information, edit biodata, update their image, share social media content, and upload various other types of content.

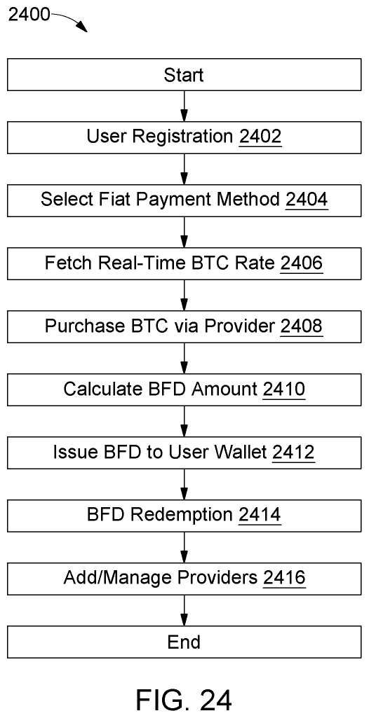

Referring to FIG. 24, illustrates a flowchart describing a process 2400 for users to convert fiat currency into a platform-native digital currency called BlackFlame® Dollar (BFD) in accordance with another embodiment of the present disclosure. At block 2402, the users/end users 104 register on the platform of the system 100 and provide necessary authentication (KYC/AML) information.

At block 2404, the users select a fiat payment method, and the system 100 connects to a fiat-to-crypto provider for processing. Once the fiat payment is confirmed, at block 2406, the system 100 fetches real-time rate of Bitcoin (BTC) from the provider to ensure the most accurate conversion for the users.

At block 2408, the system 100 initiates an automated purchase of bitcoin from the selected provider. At block 2410, the system 100 performs internal calculations to ensure the value of the purchased bitcoin aligns with the issuance of BFD. At block 2412, the corresponding amount of BFD, based on the fixed ratio of the bitcoin for example, 1/10000 bitcoin, is credited to the user's wallet.

At block 2414, the users may redeem BFD for bitcoin. All bitcoins purchased is stored in a dedicated treasury wallet of the treasury management system 110. The system 100 ensures that the total bitcoin in the treasury always equals or exceeds the total BFD issued, guaranteeing stability. This treasury operates on an automated smart contract-based system that locks bitcoin and facilitates withdrawal only when BFD is redeemed. the system 100 deducts the corresponding BFD from the user's account and releases the equivalent bitcoin from the treasury. At block 2416, the users can add or manage providers.

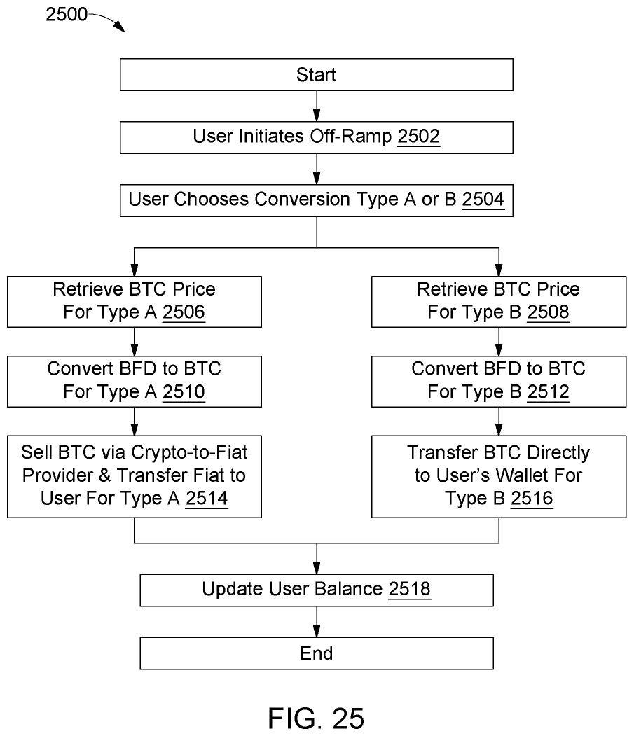

Referring to FIG. 25, illustrates a flowchart describing a process 2500 for Off-Ramp feature allows the users to convert their BlackFlame® Dollar (BFD) either into fiat currency or directly into bitcoin in accordance with another embodiment of the present disclosure. At block 2502, a user holding BFD initiates a request to convert it back into either fiat currency or bitcoin.

At block 2504, two options (type A and type B) are available to the user for selection. If the user opts for bitcoin, they input their wallet address. If they choose fiat, the system 100 handles the conversion through an integrated crypto-to-fiat provider. When the user chooses fiat (Type A), at block 2506, the system 100 retrieves BTC price of the user then at block 2510, the platform of the system 100 uses a crypto-to-fiat provider to convert the user's BFD into bitcoin. And at block 2514, the bitcoin is sold via crypto-to-fiat provider, and the fiat equivalent is transferred to the user's account.

And if the user chooses direct bitcoin (Type B), at block 2508, the system 100 retrieves BTC price for the user then at block 2512, the system 100 uses a crypto-to-fiat provider to convert the user's BFD into bitcoin.

And at block 2516, the user can provide their bitcoin wallet address, and the platform transfers bitcoin directly to fiat wallet, based on the pegged value of BFD. At block 2518, after transfer, the user balance is updated in the account based on the transfer.

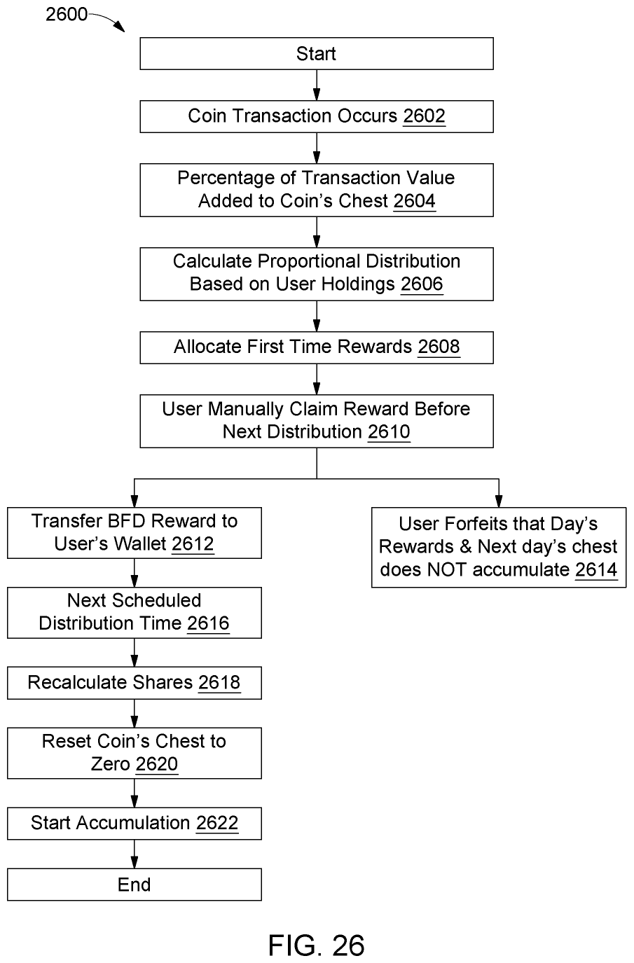

Referring to FIG. 26, illustrates a flowchart describing a process 2600 for performing dynamic community chest mechanism to collect a percentage of all coins bought and sold on the platform of the system 100 in accordance with another embodiment of the present disclosure. At block 2602, the process starts with a coin transaction by the user. At block 2604, a predefined percentage of each coin transaction is diverted into that coin's community chest.

At block 2606, the system 100 calculates each user's share of the community chest based on their coin holdings. The users receive their rewards in proportion to their total coin ownership. At block 2608, the calculated user's share is allocated to the user.

At block 2610, the user manually claims their rewards from the community chest periodically. If the user does not claim their rewards, at block 2614, the community chest mechanism stops accumulating for the user, and the user do not receive retroactive rewards for missed days. Only active participants benefit from periodic claims. That is the user forfeits that particular day's rewards and the next day's chest does not accumulate for the user.

If the user claims reward, at block 2612, the reward transfer BFD to user's wallet. At block 2616, set the next scheduled distribution time. At block 2618, the system 100 recalculates each user's shares. And at block 2620, the community chest mechanism resets at the end of periodic day, and at block 2622, the system 100 again starts accumulation ensuring that rewards are distributed on a regular basis without lingering or accumulating indefinitely.

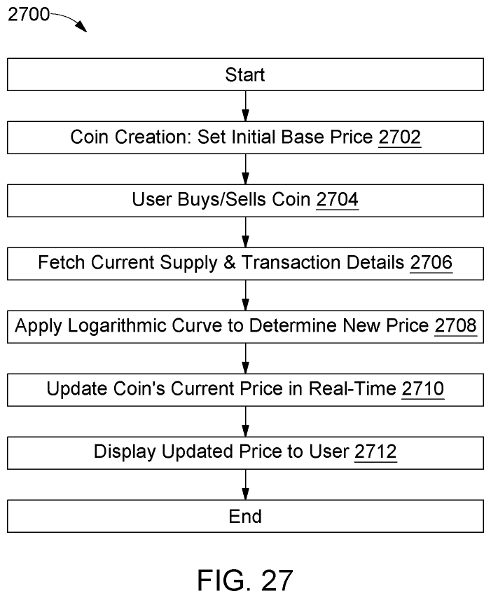

Referring to FIG. 27, illustrates a flowchart describing a process 2700 for logarithmic curve to regulate the price growth in accordance with another embodiment of the present disclosure. At block 2702, each coin starts at an initial base price in BFD, set by the creator or the platform. This base price is the lowest possible price for the coin, and as more numbers of the coin are purchased, the price increases according to a logarithmic bonding curve. At block 2704, the user buys or sells the coins and every time the user purchases a coin, the system 100 calculates the new price of the coin based on the number of units currently in circulation.

At block 2706, the system 100 fetches current supply of coins with transaction details. At block 2708, the logarithmic curve is applied, which causes the price to rise quickly at first and then slow down as the number of circulating coins increases. The pricing algorithm ensures that the price increases proportionally to the demand but flattens as the supply grows to maintain affordability at higher volumes. At block 2710, the user interface module 106 shows real-time price of each coin based on the current supply and demand, with pricing adjustments occurring after each transaction. At block 2712, the updated price of the coins is displayed to the user on the end user devices 102 using the user interface module 106.

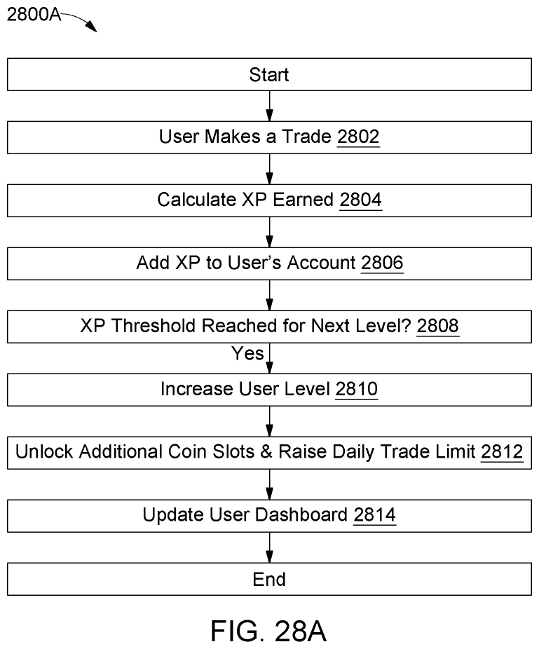

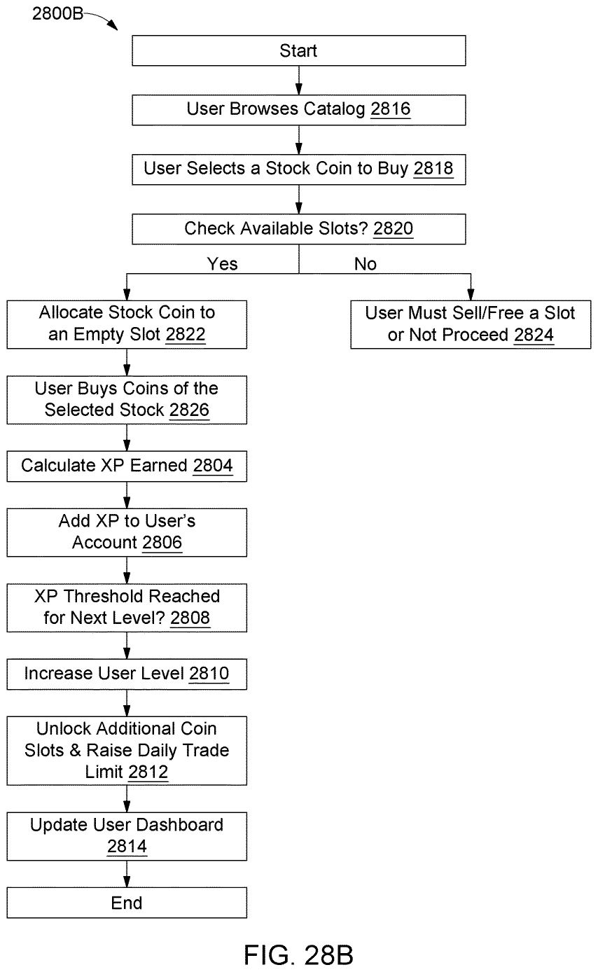

Referring to FIG. 28A, illustrates a flowchart describing a process 2800A for the users to earn Experience Points (XP) through trading activities and level up, unlocking new features such as additional coin slots and higher trade limits in accordance with another embodiment of the present disclosure.

At block 2802, the user makes a trade and at block 2804, the system 100 calculates XP Eared by the user. Users earn Experience Points (XP) for each trade they make on the platform. The amount of XP earned can vary based on the value or volume of the trade, incentivizing more active participation.

At block 2806, the experience points are added into the user's account then at block 2808, the system 100 check the XP eared by the user is greater than threshold or not. Based on block 2808, if XP reaches a threshold value, then at block 2810, the system 100 increases the level for the user. Each level unlocks new features, primarily additional coin slots and higher daily trade limits.

At block 2812, the ability to unlock more coin slots is granted, allowing the users to hold or trade a larger variety of coins simultaneously. At block 2814, the users can track their XP, levels, and available coin slots via a personalized dashboard. The system 100 provides a visual progress tracker, showing how much XP is needed to reach the next level and the benefits unlocked at each level.

Referring to FIG. 28B, illustrates a flowchart describing a process 2800B for the users earn XP through trading activities and level up, unlocking new features such as additional coin slots and higher trade limits based on availability of slots in accordance with another embodiment of the present disclosure. At block 2816, the process begins with the user browsers catalog where the system 100 display multiple user-generated stock coins in a catalog format resembling a streaming service's browsing experience that allows the users to explore and select stocks easily.

At block 2818, the user selects a stock coin to buy. At block 2820, the system 100 checks the available slots of the user and if the user does not have available slots at block 2824, the user may sell or free a slot to proceed or not proceed. If the user has available slots at block 2822, the system 100 allocates stock coin to an empty slot. At block 2826, the user buys coins of the selected stock and at block 2804, the system 100 calculates XP eared by the user. Blocks 2806, 2808, 2810, 2812, 2814 are as previously explained drawing FIG. 28A.

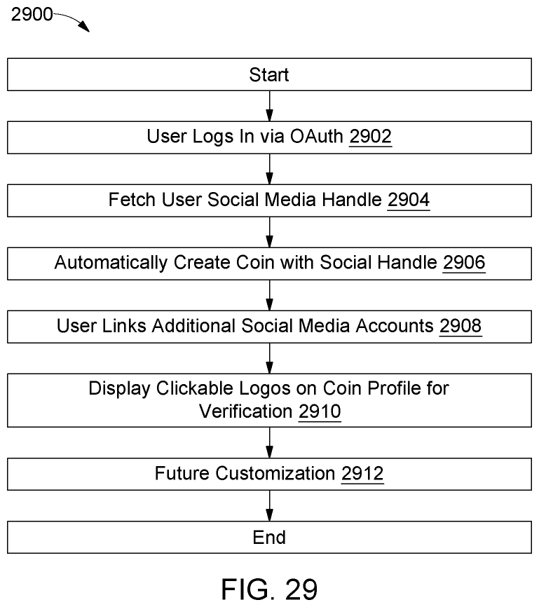

Referring to FIG. 29, illustrates a flowchart describing a process 2900 for social media integration for coin creation and verification in accordance with another embodiment of the present disclosure. At block 2902, the users can sign into the platform via OAuth tokens and authentication process. The system 100 uses OAuth to allow the users to securely log in with their social media credentials, streamlining the registration and coin creation process.

At block 2904, the system 100 fetches the users social media handle using OAuth. At block 2906, the system 100 uses the user's social media credentials to automatically generate a coin on the users behalf. A proprietary system automatically generates coins for the users based on their social media profile data, reducing the manual effort required for coin creation.

At block 2908, the users can link additional social media accounts to their profile. At block 2910, the system 100 displays clickable logos for each linked social media platform, allowing viewers to verify the authenticity of the coin creator. The social media logos appear on the coin's profile page, and each logo links directly to the respective account, ensuring that the creator's identity is easily verified. At block 2912, the users will have the option to customize their coins by uploading a new image or changing the coin name in future iterations of the system 100.

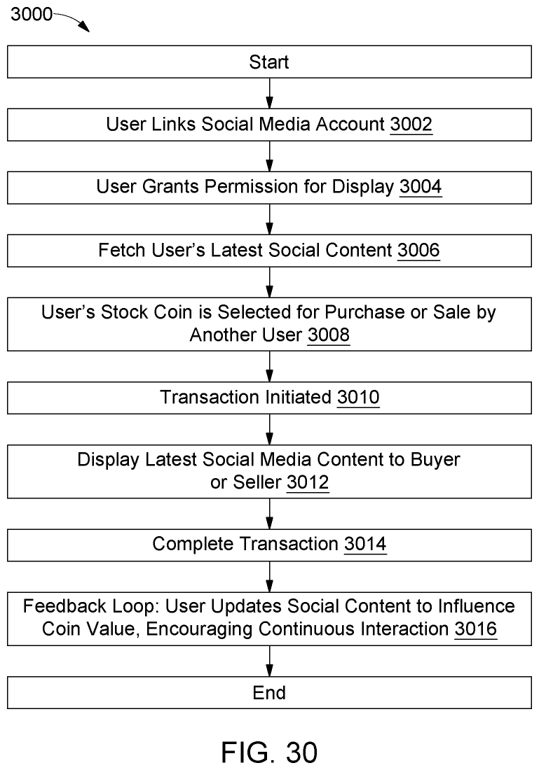

Referring to FIG. 30, illustrates a flowchart describing a process 3000 for a digital trading platform that integrates real-time social media content with user-generated stock coins in accordance with another embodiment of the present disclosure. At block 3002, the users link their social media accounts to the system 100. At block 3004, using the OAuth protocols, the users securely grant the platform permission to access their stories or shorts. At block 3006, the system 100 fetches the user's latest content from their social media accounts. Content is cached for efficient retrieval during high-volume transactions.

At block 3008, the user's stock coin is selected for purchase or sale by another user. The user purchases another user's stock, or coin. The buyer's interface displays the seller's latest content. Else the user sells a stock coin and the seller's interface displays the latest content of the stock coin's owner. At block 3010, transaction is initiated for the user.

At block 3012, display latest social media content to buyer or seller and at block 3014, the transaction is completed by transferring stock coin and adjust price via influence index and bonding curve.

At block 3016, the users observe that updating their social media content can influence their stock valuation. Changes in stock valuation may prompt the users to create new content to address market movements.

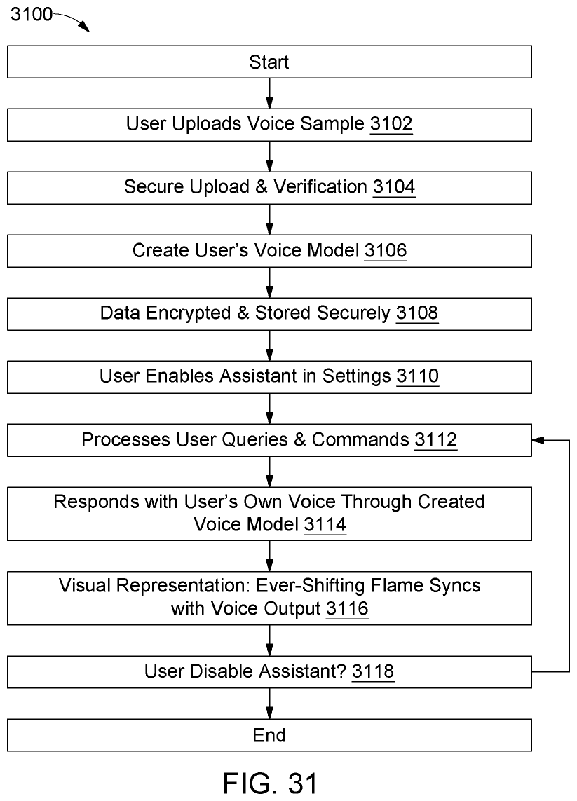

Referring to FIG. 31, illustrates a flowchart describing a process 3100 for a personalized AI assistant that replicates a user's voice and provides guidance within the system 100 in accordance with another embodiment of the present disclosure. At block 3102, the users are prompted to upload a voice sample, following guidelines to ensure clarity and quality.

At block 3104, the voice sample is securely uploaded to the server. At block 3106, the user's voice sample is uploaded using voice synthesis and deep learning algorithms to create a digital voice model replicating the user's voice.

At block 3108, the voice data is encrypted and stored securely. Access to the voice model is restricted to the user's interactions within the system 100. At block 3110, the user enables the AI assistant to function by selecting the AI assistant in settings.

At block 3112, an Al assistant engine that generates responses to the user queries and interactions. At block 3114, the AI Assistant engine generates responses based on the user input and platform data. Responses are synthesized using the user's voice model for audio playback.

At block 3116, the AI assistant is visually depicted as an ever-shifting flame, embodying the BlackFlame logo syncs with voice output. The flame moves fluidly, responding to the user interactions and voice activity. At block 3118, the users can easily enable or disable the AI assistant at any time via the settings.

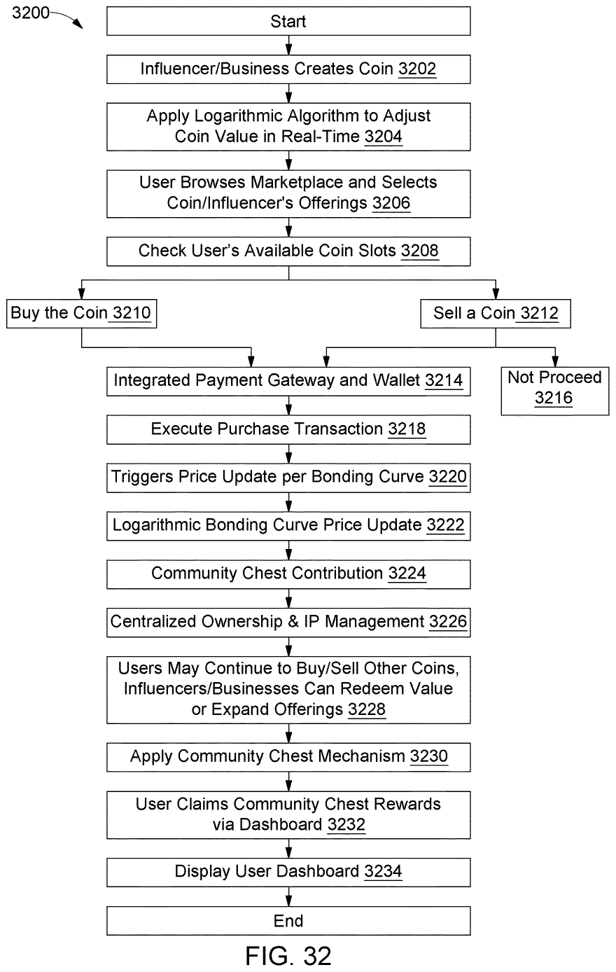

Referring to FIG. 32, illustrates a flowchart describing a process 3200 for allowing influencers and individual businesses to create and manage proprietary digital coins in accordance with another embodiment of the present disclosure. At block 3202, influencers and businesses create and manage their own coins. At block 3204, a logarithmic algorithm is used to adjust coin value in real-time based on supply and demand dynamics through minting and burning processes.

At block 3206, coin value reflects real-time market activity, influenced by the coin creator's engagement and offerings. Influencers and businesses price their offerings in their own coins. Users acquire the coin to make purchases, directly linking coin demand to the attractiveness of the offerings. The user browses marketplace and selects coin/influencer's offerings.

At block 3208, the system 100 checks the available slots of the user and if the user does not have available slots at block 3212, the user sells a coin to proceed or at block 3216, not proceed.

If the user has available slots, then at block 3210, the user buys the coin and further at block 3214, facilitates seamless transactions across multiple platforms with automatic fiat-to-coin conversion capabilities.

At block 3218, the coin purchase transactions are executed, and the user can pay in fiat or crypto and gateway converts fiat.

At block 3220, price update is triggered per bonding curve. Equivalent fiat/crypto is deducted from the user and coin is transferred to user's slot. This will increase in demand for coins.

At block 3222, price update is triggered via a logarithmic bonding curve. Logarithmic bonding curve price is updated by fetching current supply and transaction details. The logarithmic curve is applied to determine new price. The coin's current price is updated in real-time and the updated price is displayed to the user.

At block 3224, a percentage of each transaction is allocated to the coin's community chest. At block 3226, centralized ownership and IP management is performed. The platform retains ownership of all coins and associated content and manages integration with external services if needed.

At block 3228, the users may continue to buy/sell other coins, and the influencers/businesses can redeem value or expand offerings. Pricing updates as transactions occur.

At block 3230, apply community chest mechanism discussed before in previous figures. At block 3232, the user claims community chest rewards via dashboard displayed on the end user device 102.

At block 3234, the user dashboard is displayed to the user using the user interface module 106 on the end user device 102. The user dashboard includes details of the coins, XP, wallet amount, profiles etc.

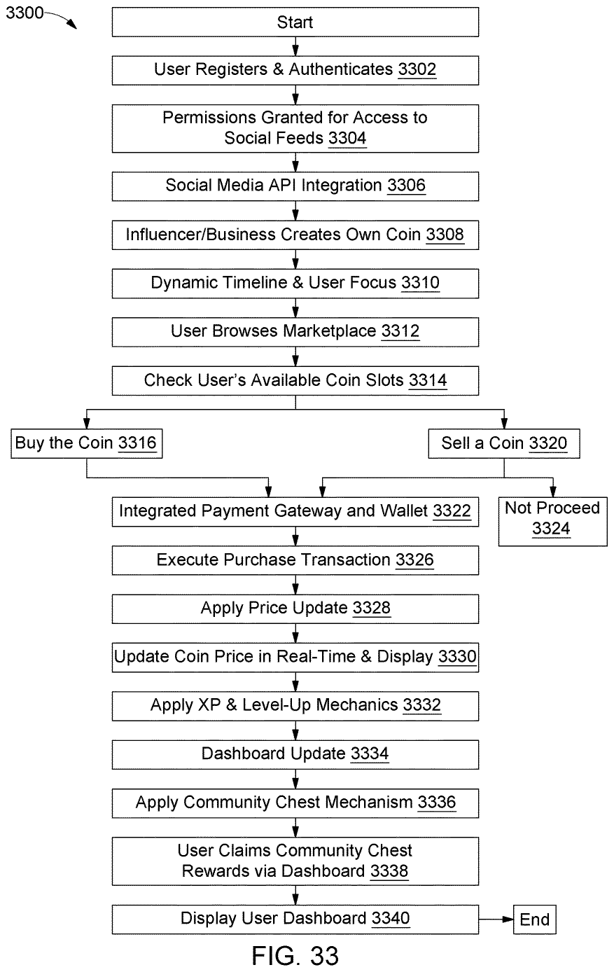

Referring to FIG. 33, illustrates a flowchart describing a process 3300 for aggregated dynamic social media timeline integration in a user investment platform in accordance with another embodiment of the present disclosure. At block 3302, users register on the platform and create profiles. Authentication is managed through protocols like OAuth.

At block 3304, users can connect their social media accounts using OAuth2 authentication protocols. Users are granted permissions to the platform of the system 100 to access specific types of data (e.g., posts, stories). Users can select which content is shared on the platform.

At block 3306, the system 100 uses APIs provided by each social media platform to fetch the user content. At block 3308, influencers or businesses create their own coins. At block 3310, the dynamic timeline is presented as a continuous, scrollable feed and displayed as aggregated content in chronological order. The timeline focuses on that user's aggregated social media content. The timeline updates dynamically as new content is fetched. Users can see the latest activities without manual refresh.

At block 3312, the user browses the marketplace and at block 3314, the system 100 checks the available coin slots of the user and if the user does not have available slots, then at block 3320, the user sells a coin and at block 3324, does not proceed further.

If the user has available coin slots, then at block 3316, the user buys coins using integrated payment gateway and wallet at block 3322, the user facilitates seamless transactions across multiple platforms with automatic fiat-to-coin conversion capabilities. At block 3322, the system 100 facilitates seamless transactions across multiple platforms with automatic fiat-to-coin conversion capabilities.

At block 3326, the purchase transaction of the coin is executed, and the user can pay in fiat or crypto and gateway converted fiat. At block 3328, the updated price is applied and at block 3330, the coin price is updated in real-time and displayed to the user.

At block 3332, experience points (XP) and level-up mechanism is applied. At block 3334, the dashboard on the end user device 102 is updated according to level-up mechanism. At block 3336, community chest mechanism is applied. At block 3338, the user claims community chest rewards via dashboard.

At block 3340, the user dashboard is displayed to the user using the user interface module 106 on the end user device 102. The user dashboard includes details of the coins, XP, wallet amount, profiles etc.

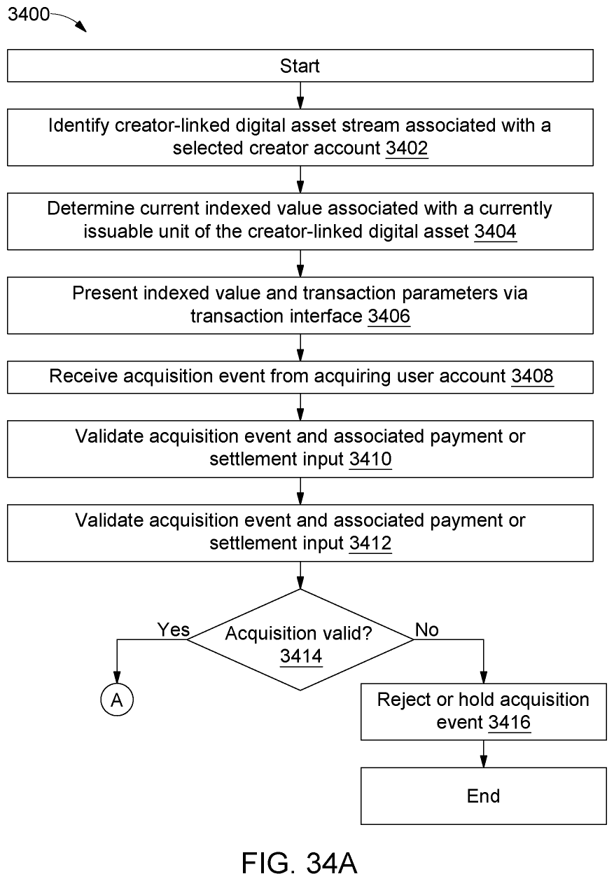

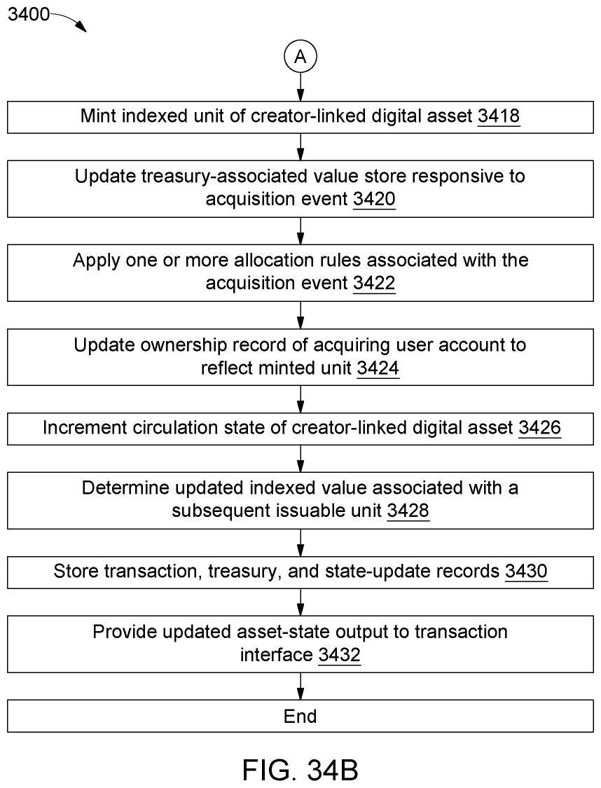

Referring to FIGS. 34A and 34B, an exemplary process 3400 for performing buy-side event-driven minting and state advancement associated with a creator-linked digital asset is depicted via a flowchart, according to an embodiment of the present disclosure. In an embodiment, the process 3400 may be implemented via the server 102 of the system 100.

The process 3400 may include identifying a creator-linked digital asset stream associated with a selected creator account, at step 3402.

Further, the process 3400 may include determining a current indexed value associated with a currently issuable unit of the creator-linked digital asset, at step 3404.

Further, the process 3400 may include presenting the indexed value and transaction parameters via a transaction interface, at step 3406.

Further, the process 3400 may include receiving an acquisition event from an acquiring user account, at step 3408.

Further, the process 3400 may include validating the acquisition event and associated payment or settlement input, at steps 3410 and 3412.

Further, the process 3400 may include determining whether the acquisition event is valid, at step 3414. Responsive to determining that the acquisition event is invalid, the process 3400 may include rejecting or holding the acquisition event, at step 3416.

Responsive to determining that the acquisition event is valid, the process 3400 may include minting an indexed unit of the creator-linked digital asset, at step 3418.

Further, the process 3400 may include updating a treasury-associated value store responsive to the acquisition event, at step 3420.

Further, the process 3400 may include applying one or more allocation rules associated with the acquisition event, at step 3422.

Further, the process 3400 may include updating an ownership record of the acquiring user account to reflect the minted unit, at step 3424.

Further, the process 3400 may include incrementing a circulation state of the creator-linked digital asset, at step 3426.

Further, the process 3400 may include determining an updated indexed value associated with a subsequent issuable unit, at step 3428.

Further, the process 3400 may include storing transaction records, treasury records, and state-update records, at step 3430.

Further, the process 3400 may include providing updated asset-state output to the transaction interface, at step 3432.

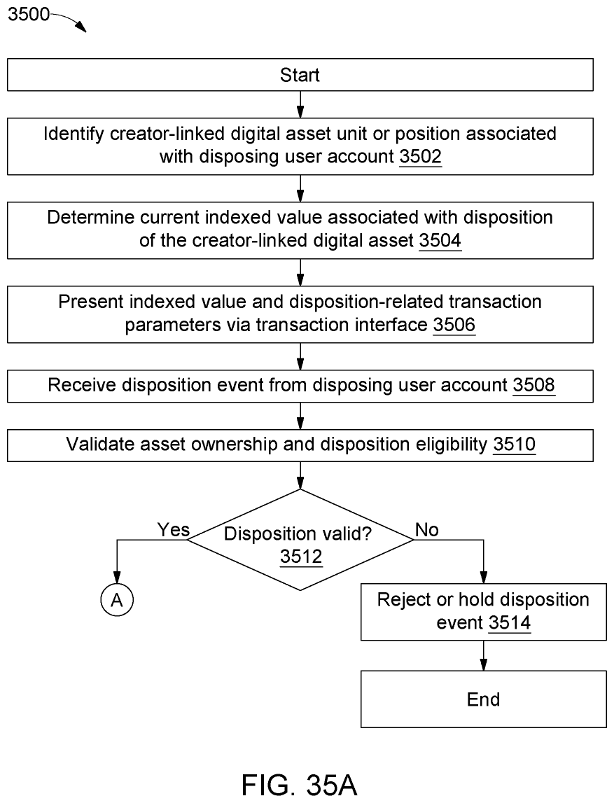

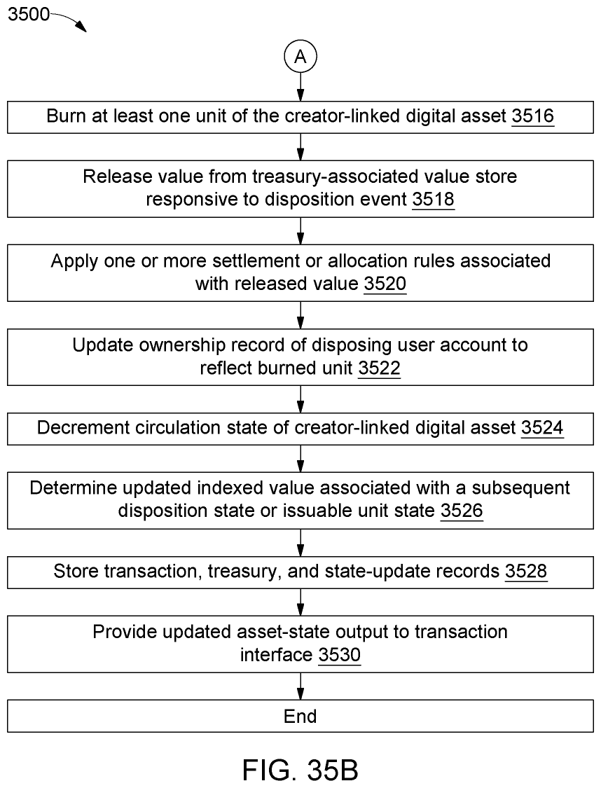

Referring to FIGS. 35A and 35B, an exemplary process 3500 for performing sell-side event-driven burning and state reduction associated with a creator-linked digital asset is depicted via a flowchart, according to an embodiment of the present disclosure. In an embodiment, the process 3500 may be implemented via the server 102 of the system 100.

The process 3500 may include identifying a creator-linked digital asset unit or position associated with a disposing user account, at step 3502.

Further, the process 3500 may include determining a current indexed value associated with disposition of the creator-linked digital asset, at step 3504.

Further, the process 3500 may include presenting indexed value and disposition-related transaction parameters via a transaction interface, at step 3506.

Further, the process 3500 may include receiving a disposition event from the disposing user account, at step 3508.

Further, the process 3500 may include validating asset ownership and disposition eligibility, at step 3510.

Further, the process 3500 may include determining whether the disposition event is valid, at step 3512. Responsive to determining that the disposition event is invalid, the process 3500 may include rejecting or holding the disposition event, at step 3514.

Responsive to determining that the disposition event is valid, the process 3500 may include burning at least one unit of the creator-linked digital asset, at step 3516.

Further, the process 3500 may include releasing value from a treasury-associated value store responsive to the disposition event, at step 3518.

Further, the process 3500 may include applying one or more settlement or allocation rules associated with the released value, at step 3520.

Further, the process 3500 may include updating an ownership record of the disposing user account to reflect the burned unit, at step 3522.

Further, the process 3500 may include decrementing a circulation state of the creator-linked digital asset, at step 3524.

Further, the process 3500 may include determining an updated indexed value associated with a subsequent disposition state or issuable unit state, at step 3526.

Further, the process 3500 may include storing transaction records, treasury records, and state-update records, at step 3528.

Further, the process 3500 may include providing updated asset-state output to the transaction interface, at step 3530.

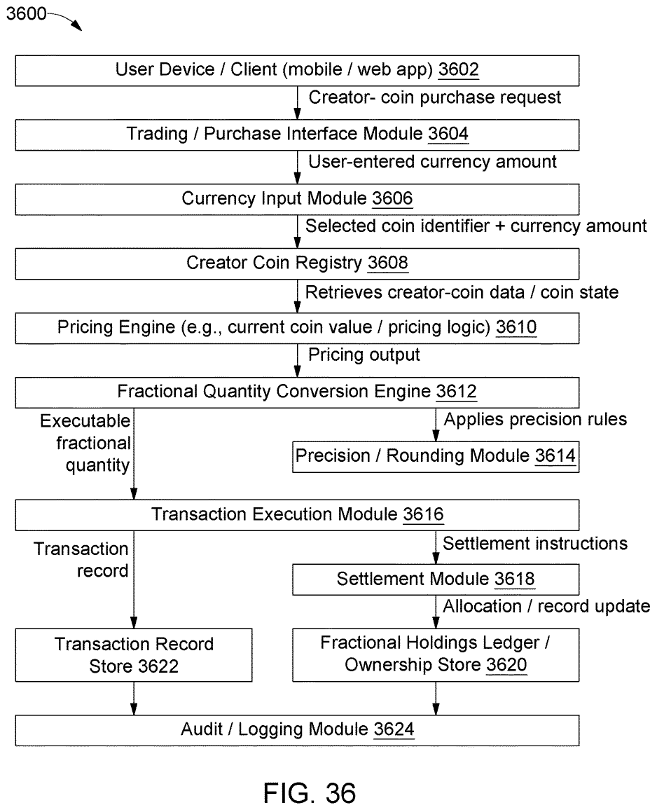

Referring to FIG. 36, an exemplary system architecture 3600 for executing, pricing, allocating, and recording fractional ownership interests associated with creator-linked coins is depicted, according to an embodiment of the present disclosure.

In an embodiment, the system architecture 3600 may include a user device or client device 3602 configured to transmit a creator-coin purchase request to a trading or purchase interface module 3604.

Further, the trading or purchase interface module 3604 may receive a user-entered currency amount associated with acquisition of a creator-linked coin and provide the currency amount to a currency input module 3606.

Further, the currency input module 3606 may provide a selected coin identifier and the currency amount to a creator coin registry 3608.

Further, the creator coin registry 3608 may retrieve creator-coin data and coin-state information associated with the selected creator-linked coin and provide the creator-coin data and coin-state information to a pricing engine 3610.

Further, the pricing engine 3610 may determine a current coin value or pricing output associated with the selected creator-linked coin and provide the pricing output to a fractional quantity conversion engine 3612.

Further, the fractional quantity conversion engine 3612 may determine an executable fractional quantity associated with the creator-linked coin based on the currency amount and the pricing output.

In an embodiment, the fractional quantity conversion engine 3612 may further interact with a precision or rounding module 3614 configured to apply precision rules associated with the executable fractional quantity.

Further, the executable fractional quantity may be provided to a transaction execution module 3616 configured to execute a transaction corresponding to the executable fractional quantity.

Further, the transaction execution module 3616 may provide settlement instructions to a settlement module 3618.

Further, the settlement module 3618 may perform allocation or record updating operations associated with the executable fractional quantity and provide corresponding information to a fractional holdings ledger or ownership store 3620.

Further, the transaction execution module 3616 may provide transaction records to a transaction record store 3622.

Further, the fractional holdings ledger or ownership store 3620 and the transaction record store 3622 may communicate with an audit or logging module 3624 configured to maintain transaction logs, allocation records, and audit-related information associated with creator-linked coin transactions.

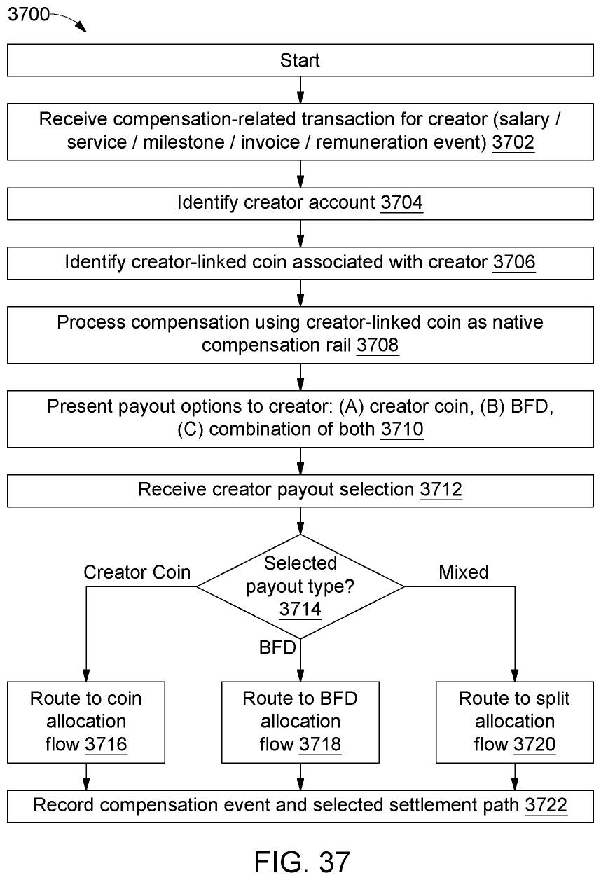

Referring to FIG. 37, an exemplary process 3700 for compensating a creator using a creator-linked coin and selectable settlement architecture is depicted via a flowchart, according to an embodiment of the present disclosure. In an embodiment, the process 3700 may be implemented via the server 102 of the system 100.

The process 3700 may include receiving a compensation-related transaction for a creator associated with salary, service, milestone, invoice, or remuneration event, at step 3702.

Further, the process 3700 may include identifying a creator account, at step 3704.

Further, the process 3700 may include identifying a creator-linked coin associated with the creator, at step 3706.

Further, the process 3700 may include processing compensation using the creator-linked coin as a native compensation rail, at step 3708.

Further, the process 3700 may include presenting payout options to the creator including creator coin settlement, BFD settlement, or a combination thereof, at step 3710.

Further, the process 3700 may include receiving a creator payout selection, at step 3712.

Further, the process 3700 may include determining a selected payout type, at step 3714. Responsive to determining that the selected payout type corresponds to creator coin settlement, the process 3700 may include routing the compensation transaction to a coin allocation flow, at step 3716. Responsive to determining that the selected payout type corresponds to BFD settlement, the process 3700 may include routing the compensation transaction to a BFD allocation flow, at step 3718. Responsive to determining that the selected payout type corresponds to mixed settlement, the process 3700 may include routing the compensation transaction to a split allocation flow, at step 3720.

Further, the process 3700 may include recording the compensation event and selected settlement path, at step 3722.

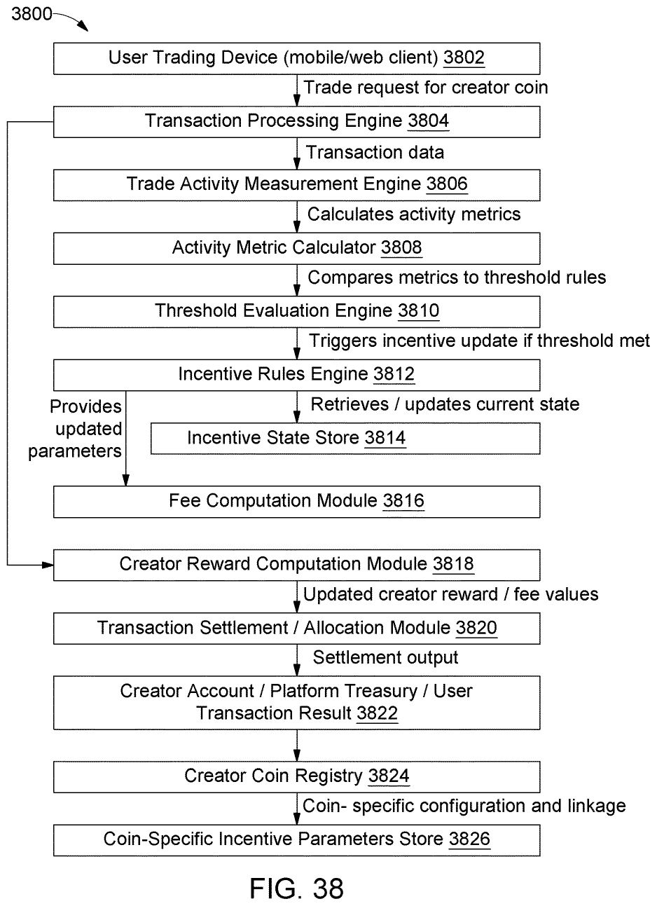

Referring to FIG. 38, an exemplary system architecture 3800 for dynamically adjusting creator-linked incentive parameters based on creator-coin activity metrics is depicted, according to an embodiment of the present disclosure.

In an embodiment, a user trading device 3802 may transmit a trade request for a creator coin to a transaction processing engine 3804.

Further, the transaction processing engine 3804 may provide transaction data to a trade activity measurement engine 3806 configured to calculate activity metrics associated with creator-coin trading activity.

Further, the trade activity measurement engine 3806 may provide the activity metrics to an activity metric calculator 3808 configured to compare the activity metrics against threshold rules.

Further, a threshold evaluation engine 3810 may determine whether one or more incentive update conditions are satisfied and may trigger an incentive update responsive to determining that the threshold conditions are satisfied.

Further, an incentive rules engine 3812 may retrieve or update current incentive states maintained within an incentive state store 3814.

Further, the incentive rules engine 3812 may provide updated parameters to a fee computation module 3816 and a creator reward computation module 3818.

Further, updated creator reward values and fee values may be transmitted to a transaction settlement or allocation module 3820 configured to generate settlement outputs.

Further, the settlement outputs may be provided to a creator account, platform treasury, or user transaction result interface 3822.

Further, a creator coin registry 3824 may maintain coin-specific configuration and linkage information associated with creator-linked coins and may communicate with a coin-specific incentive parameters store 3826.

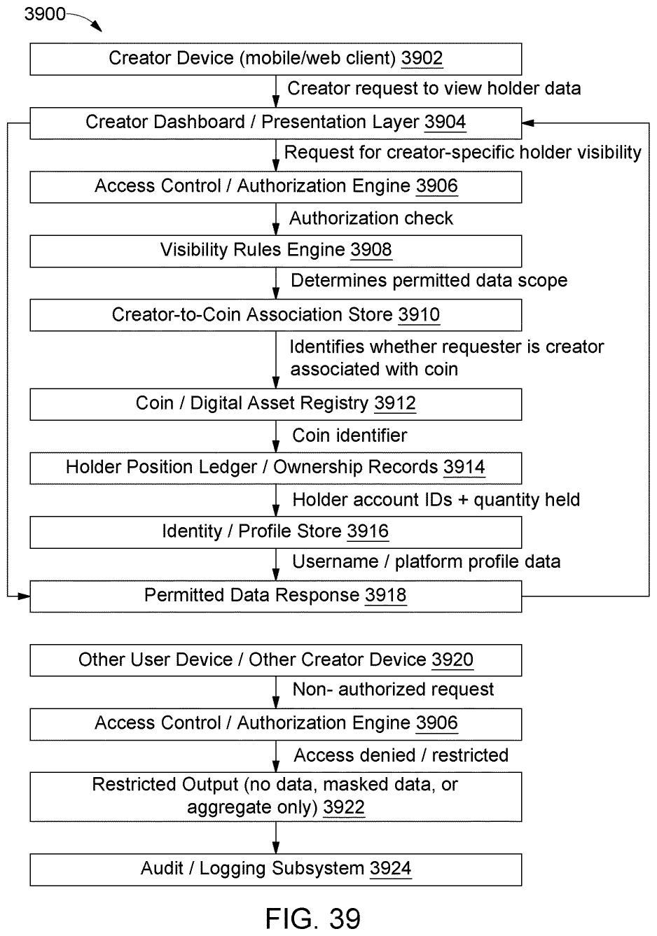

Referring to FIG. 39, an exemplary system architecture 3900 for selective visibility of creator-linked digital asset holder information is depicted, according to an embodiment of the present disclosure.

In an embodiment, a creator device 3902 may transmit a creator request to view holder data to a creator dashboard or presentation layer 3904.

Further, the creator dashboard or presentation layer 3904 may provide a request for creator-specific holder visibility to an access control or authorization engine 3906.

Further, the access control or authorization engine 3906 may perform an authorization check and communicate with a visibility rules engine 3908 configured to determine a permitted data scope.

Further, the visibility rules engine 3908 may communicate with a creator-to-coin association store 3910 configured to identify whether a requester corresponds to a creator associated with a creator-linked coin.

Further, the creator-to-coin association store 3910 may communicate with a coin or digital asset registry 3912 configured to identify a coin identifier associated with the creator-linked coin.

Further, the coin or digital asset registry 3912 may communicate with a holder position ledger or ownership records datastore 3914 configured to retrieve holder account identifiers and quantity-held information associated with the creator-linked coin.

Further, the holder position ledger or ownership records datastore 3914 may communicate with an identity or profile store 3916 configured to retrieve username information and platform profile data associated with holder accounts.

Further, the retrieved holder information may be provided as a permitted data response 3918 to the creator dashboard or presentation layer 3904 responsive to successful authorization of the requester.

In an embodiment, a non-authorized request may be received from another user device or another creator device 3920. The access control or authorization engine 3906 may deny or restrict access responsive to the non-authorized request.

Further, a restricted output 3922 including no data, masked data, or aggregate-only information may be generated responsive to determining that the requester is not authorized.

Further, an audit or logging subsystem 3924 may maintain authorization logs, visibility-event logs, and restricted-access records associated with holder-information access operations.

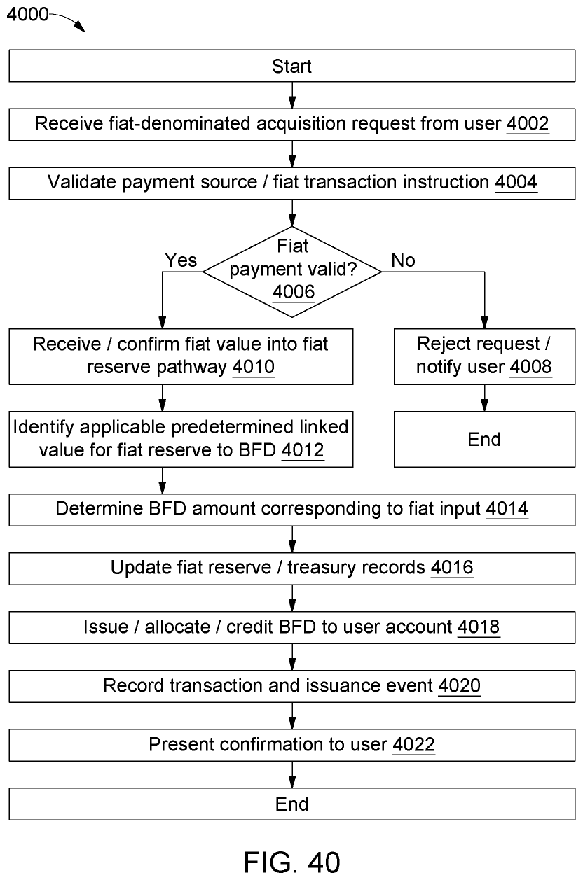

Referring to FIG. 40, an exemplary process 4000 for direct fiat-backed BFD issuance and reserve management is depicted via a flowchart, according to an embodiment of the present disclosure. In an embodiment, the process 4000 may be implemented via the server 102 of the system 100.

The process 4000 may include receiving a fiat-denominated acquisition request from a user, at step 4002.

Further, the process 4000 may include validating a payment source or fiat transaction instruction associated with the fiat-denominated acquisition request, at step 4004.

Further, the process 4000 may include determining whether the fiat payment is valid, at step 4006. Responsive to determining that the fiat payment is invalid, the process 4000 may include rejecting the request or notifying the user, at step 4008.

Responsive to determining that the fiat payment is valid, the process 4000 may include receiving or confirming fiat value into a fiat reserve pathway, at step 4010.

Further, the process 4000 may include identifying an applicable predetermined linked value associated with fiat reserve to BFD conversion, at step 4012.

Further, the process 4000 may include determining a BFD amount corresponding to the fiat input, at step 4014.

Further, the process 4000 may include updating fiat reserve or treasury records, at step 4016.

Further, the process 4000 may include issuing, allocating, or crediting BFD to a user account, at step 4018.

Further, the process 4000 may include recording a transaction and issuance event, at step 4020.

Further, the process 4000 may include presenting confirmation to the user, at step 4022.

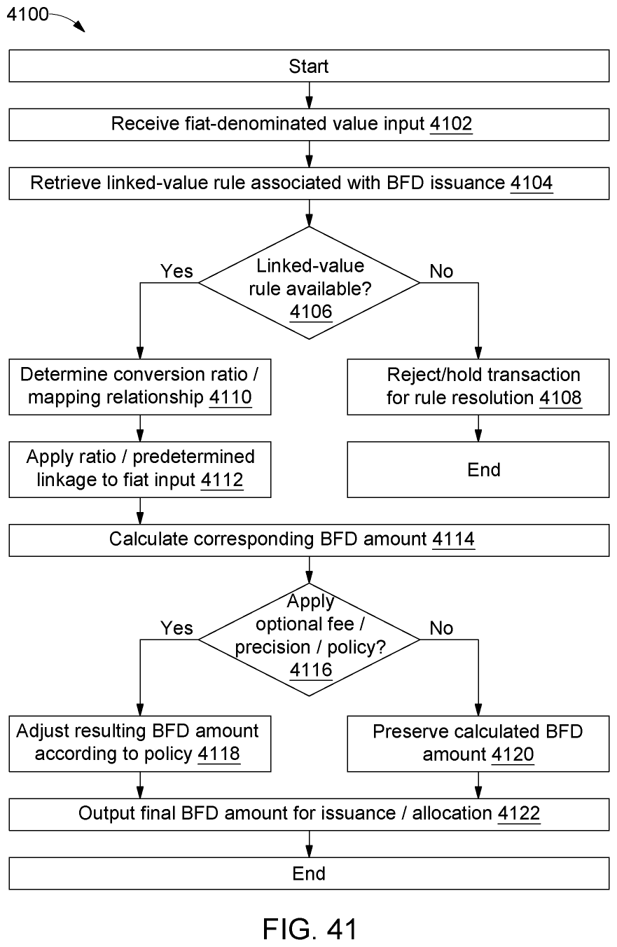

Referring to FIG. 41, an exemplary process 4100 for reserve linkage and value determination associated with BFD issuance is depicted via a flowchart, according to an embodiment of the present disclosure. In an embodiment, the process 4100 may be implemented via the server 102 of the system 100.

The process 4100 may include receiving a fiat-denominated value input, at step 4102.

Further, the process 4100 may include retrieving a linked-value rule associated with BFD issuance, at step 4104.

Further, the process 4100 may include determining whether the linked-value rule is available, at step 4106. Responsive to determining that the linked-value rule is unavailable, the process 4100 may include rejecting or holding the transaction for rule resolution, at step 4108.

Responsive to determining that the linked-value rule is available, the process 4100 may include determining a conversion ratio or mapping relationship, at step 4110.

Further, the process 4100 may include applying the ratio or predetermined linkage to the fiat input, at step 4112.

Further, the process 4100 may include calculating a corresponding BFD amount, at step 4114.

Further, the process 4100 may include determining whether an optional fee, precision rule, or policy is applicable, at step 4116.

Responsive to determining that the optional fee, precision rule, or policy is applicable, the process 4100 may include adjusting the resulting BFD amount according to the policy, at step 4118. Responsive to determining that the optional fee, precision rule, or policy is not applicable, the process 4100 may include preserving the calculated BFD amount, at step 4120.

Further, the process 4100 may include outputting a final BFD amount for issuance or allocation, at step 4122.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, non-volatile, or other storage medium and is not to be limited to any particular type of memory or number of memories, or type of media upon which memory is stored.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data. These machine-readable instructions may be stored on one or more machine-readable mediums, such as CD-ROMs or other type of optical disks, solid-state drives, tape cartridges, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Implementation of the techniques, blocks, steps, and means described above may be done in various ways. For example, these techniques, blocks, steps, and means may be implemented in hardware, software, or a combination thereof. For a digital hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. For analog circuits, they can be implemented with discreet components or using monolithic microwave integrated circuit (MMIC), radio frequency integrated circuit (RFIC), and/or micro electro-mechanical systems (MEMS) technologies.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

While the principles of the disclosure have been described above in connection with specific apparatuses and methods, it is to be clearly understood that this description is made only by way of example and not as limitation on the scope of the disclosure.

What is claimed is:

1. A method for dynamically maintaining a creator-linked digital asset platform, the method comprising:
receiving, by a server from one or more data sources, heterogeneous real-time event data streams corresponding to a creator and a current circulation state corresponding to a creator-linked digital asset associated with the creator, wherein the real-time event data comprises a set of asynchronous data elements;
preprocessing, by the server, the heterogeneous real-time event data streams to determine a set of activity metrics;
synchronizing, by the server, the standardized activity metrics with the circulation state to generate a composite state representation;
dynamically determining, by the server, a current indexed value of the creator-linked digital asset based on the composite state representation using a predefined valuation function; and
outputting, by the server, the current indexed value to a transaction interface for enabling subsequent operations associated with the creator-linked digital asset.

2. The method of claim 1, further comprising storing the current indexed value of the creator-linked digital asset in a state database contemporaneous to outputting of the current indexed value.

3. The method of claim 2, wherein dynamically determining the current indexed value comprises:
maintaining, within the state database, a reserve corresponding to issued units of the creator-linked digital asset, the reserve being updated responsive to acquisition requests and disposition requests associated with the creator-linked digital asset; and
computing the current indexed value based at least in part on a relationship between the reserve and the circulation state.

4. The method of claim 3, further comprising maintaining the circulation state of the creator-linked digital asset based on the subsequent operations using a set of predefined rules.

5. The method of claim 4, wherein maintaining the circulation state comprises:
triggering one of a minting event or a burning event associated with one or more units of the creator-linked digital asset;
generating, responsive to the minting event, one or more new units of the creator-linked digital asset into circulation, and updating the circulation state to reflect an increase in the issued units of the creator-linked digital asset; and
withdrawing, responsive to the burning event, one or more existing units of the creator-linked digital asset from circulation, and updating the circulation state to reflect a decrease in the issued units of the creator-linked digital asset.

6. The method of claim 5, wherein the subsequent operations correspond to triggering of one or more transaction actions.

7. The method of claim 6, wherein the one or more transaction actions correspond to an acquisition request associated with the creator-linked digital asset, and wherein enabling the subsequent operations further comprises:
updating the reserve responsive to the acquisition request;
triggering the minting event responsive to the acquisition request;
generating the one or more new units of the creator-linked digital asset into circulation responsive to the minting event;
updating the circulation state based on the generated one or more new units; and
assigning a fractional quantity of the creator-linked digital asset to the user account, wherein the fractional quantity is reflected in an ownership record of the user account.

8. The method of claim 6, wherein the one or more transaction actions correspond to a disposition request associated with the creator-linked digital asset, and wherein enabling the subsequent operations further comprises:
receiving the disposition request associated with the one or more existing units of the creator-linked digital asset from the user account;
triggering the burning event responsive to the disposition request;
withdrawing the one or more existing units of the creator-linked digital asset from circulation responsive to the burning event;
updating the ownership record associated with the user account based on the burning event;
updating the circulation state to reflect removal of the one or more existing units from circulation;
releasing at least a portion of the reserve responsive to the disposition request; and
allocating a payout to the user account based on the released portion of the reserve.

9. A system for dynamically maintaining a creator-linked digital asset platform, the system comprising:
a processor; and
a memory communicatively coupled to the processor, wherein the memory stores processor instructions, which when executed by the processor, cause the processor to:
receive, from one or more data sources, heterogeneous real-time event data streams corresponding to a creator and a current circulation state corresponding to a creator-linked digital asset associated with the creator, wherein the real-time event data comprises a set of asynchronous data elements;
preprocess the heterogeneous real-time event data streams to determine a set of activity metrics;
synchronize the standardized activity metrics with the circulation state to generate a composite state representation;
dynamically determine a current indexed value of the creator-linked digital asset based on the composite state representation using a predefined valuation function; and
output the current indexed value to a transaction interface for enabling subsequent operations associated with the creator-linked digital asset.

10. The system of claim 9, wherein the processor instructions, when executed by the processor, further cause the processor to store the current indexed value of the creator-linked digital asset in a state database contemporaneous to outputting of the current indexed value.

11. The system of claim 10, wherein to dynamically determine the current indexed value, the processor instructions, when executed by the processor, cause the processor to:
maintain, within the state database, a reserve corresponding to issued units of the creator-linked digital asset, the reserve being updated responsive to acquisition requests and disposition requests associated with the creator-linked digital asset; and
compute the current indexed value based at least in part on a relationship between the reserve and the circulation state.

12. The system of claim 11, wherein the processor instructions, when executed by the processor, further cause the processor to maintain the circulation state of the creator-linked digital asset based on the subsequent operations using a set of predefined rules.

13. The system of claim 12, wherein to maintain the circulation state, the processor instructions, when executed by the processor, cause the processor to:
trigger one of a minting event or a burning event associated with one or more units of the creator-linked digital asset;
generate, responsive to the minting event, one or more new units of the creator-linked digital asset into circulation, and updating the circulation state to reflect an increase in the issued units of the creator-linked digital asset; and
withdraw, responsive to the burning event, one or more existing units of the creator-linked digital asset from circulation, and updating the circulation state to reflect a decrease in the issued units of the creator-linked digital asset.

14. The system of claim 13, wherein the subsequent operations correspond to triggering of one or more transaction actions.

15. The system of claim 14, wherein the transaction request corresponds to an acquisition request associated with the creator-linked digital asset, and wherein to enable the subsequent operations, the processor instructions, when executed by the processor, cause the processor to:
update the reserve responsive to the acquisition request;
trigger the minting event responsive to the acquisition request;
generate the one or more new units of the creator-linked digital asset into circulation responsive to the minting event;
update the circulation state based on the generated one or more new units; and
assign the fractional quantity of the creator-linked digital asset to the user account, wherein the fractional quantity is reflected in an ownership record of the user account.

16. The system of claim 15, wherein the transaction request corresponds to a disposition request associated with the creator-linked digital asset, and wherein to enable the subsequent operations, the processor instructions, when executed by the processor, cause the processor to:
receive the disposition request associated with the one or more existing units of the creator-linked digital asset from the user account;
trigger the burning event responsive to the disposition request;
withdraw the one or more existing units of the creator-linked digital asset from circulation responsive to the burning event;
update the ownership record associated with the user account based on the burning event;
update the circulation state to reflect removal of the one or more existing units from circulation;
release at least a portion of the reserve responsive to the disposition request; and
allocate a payout to the user account based on the released portion of the reserve.

17. A non-transitory computer-readable medium storing computer-executable instructions for dynamically maintaining a creator-linked digital asset platform, the computer-executable instructions configured for:
receiving, from one or more data sources, heterogeneous real-time event data streams corresponding to a creator and a current circulation state corresponding to a creator-linked digital asset associated with the creator, wherein the real-time event data comprises a set of asynchronous data elements;
preprocessing the heterogeneous real-time event data streams to determine a set of activity metrics;
synchronizing the standardized activity metrics with the circulation state to generate a composite state representation;
dynamically determining a current indexed value of the creator-linked digital asset based on the composite state representation using a predefined valuation function; and
outputting the current indexed value to a transaction interface for enabling subsequent operations associated with the creator-linked digital asset.

18. The non-transitory computer-readable medium of claim 17, wherein the computer-executable instructions are further configured for storing the current indexed value of the creator-linked digital asset in a state database contemporaneous to outputting of the current indexed value.

19. The non-transitory computer-readable medium of claim 18, wherein for dynamically determining the current indexed value, the computer-executable instructions are configured for:
maintaining, within the state database, a reserve corresponding to issued units of the creator-linked digital asset, the reserve being updated responsive to acquisition requests and disposition requests associated with the creator-linked digital asset; and
computing the current indexed value based at least in part on a relationship between the reserve and the circulation state.

20. The non-transitory computer-readable medium of claim 19, wherein the computer-executable instructions are further configured for maintaining the circulation state of the creator-linked digital asset based on the subsequent operations using a set of predefined rules.
